(19) United States
(12) Patent Application Publication
(10) Pub. No.: US 2022/0188705 A1
(43) Pub. Date: Jun. 16, 2022

(54) INTERACTIVE DIGITAL DASHBOARDS FOR TRAINED MACHINE LEARNING OR ARTIFICIAL INTELLIGENCE PROCESSES

(71) Applicant: The Toronto-Dominion Bank, Toronto (CA)

(72) Inventors: Fatemeh Ghiyafeh DAVOODI, Toronto (CA); Elham HAJARIAN, Toronto (CA)

(21) Appl. No.: 17/542,178

(22) Filed: Dec. 3, 2021

Related U.S. Application Data
(60) Provisional application No. 63/126,392, filed on Dec. 16, 2020.

(51) Int. Cl. G06N 20/00

(52) U.S. Cl. CPC G06N 20/00

(57) ABSTRACT

The disclosed embodiments include computer-implemented processes that generate and maintain interactive digital dashboards for machine learning or artificial intelligence processes. For example, an apparatus may obtain process data associated with an execution of a plurality of machine learning or artificial intelligence processes. Based on the process data, the apparatus may determine, for each of the plurality of machine learning or artificial intelligence processes, value of one or more metrics characterizing a status of one or more operations that support the execution of the corresponding machine learning or artificial intelligence process. Further, the apparatus may transmit status data that includes the one or more metric values and corresponding process identifiers to a device, which presents, for each of the machine learning or artificial intelligence processes, a graphical representation of at least one of the determined one or more metric values within a digital interface.

### CROSS-REFERENCE TO RELATED APPLICATION

This application claims the benefit of priority under 35 U.S.C. § 119(e) to prior U.S. Provisional Application No. 63/126,392, filed Dec. 16, 2020, the disclosure of which is incorporated by reference herein to its entirety.

### TECHNICAL FIELD

The disclosed embodiments generally relate to computer-implemented processes for generate and maintain interactive digital dashboards for machine learning or artificial intelligence processes.

### BACKGROUND

Machine learning and artificial intelligence processes are widely adopted throughout the financial services industry, and an output of these machine learning and artificial intelligence process may inform decisions associated with a targeted marketing of products and services to existing and prospective customers, a credit risk associated with these existing and prospective customers, or a suspiciousness of certain activities performed by these existing and prospective customers. By way of example, a financial institution may include multiple business units, and each of the business units may adaptively train, and then deploy, one or more trained artificial intelligence or machine learning processes that generate elements of output data consistent with the needs of that business unit and on a schedule appropriate to those needs.

### SUMMARY

In some examples, an apparatus includes a communications interface, a memory storing instructions, and at least one processor coupled to the communications interface and to the memory. The at least one processor is configured to execute the instructions to obtain process data associated with an execution of a plurality of machine learning or artificial intelligence processes. The at least one processor is further configured to execute the instructions to, based on the process data, determine, for each of the plurality of machine learning or artificial intelligence processes, value of one or more metrics characterizing a status of one or more operations that support the execution of the corresponding machine learning or artificial intelligence process. The at least one processor is further configured to generate status data for each of the machine learning or artificial intelligence processes, and transmit one or more elements of the status data to a device via the communications interface. The status data includes, for each of the machine learning or artificial intelligence processes, the determined one or more metric values and a corresponding process identifier, and the status data causes the device to present, for each of the machine learning or artificial intelligence processes, a graphical representation of at least one of the determined one or more metric values within a digital interface.

In other examples, a computer-implemented method includes obtaining, using at least one processor, process data associated with an execution of a plurality of machine learning or artificial intelligence processes. The computer-implemented method also includes, based on the process data, determining, using the at least one processor, and for each of the machine learning or artificial intelligence processes, a value of one or more metrics characterizing a status of one or more operations that support the execution of the corresponding machine learning or artificial intelligence process. The computer-implemented method includes using the at least one processor, generating status data for each of the plurality of machine learning or artificial intelligence processes, and transmitting one or more elements of the status data to a device. The status data includes, for each of the machine learning or artificial intelligence processes, the determined one or more metric values and a corresponding process identifier, and the status data causes the device to present, for each of the machine learning or artificial intelligence processes, a graphical representation of at least one of the determined one or more metric values within a digital interface.

Additionally, in some examples, a device includes a communications interface, a display unit, an input unit, a memory storing instructions and at least one processor coupled to the communications interface, the display unit, the input unit, and the memory. The at least one processor is configured to execute the instructions to receive, via the communications interface, status data associated with an execution of a plurality of machine learning processes. The status data includes, for each of the plurality of machine learning processes, a process identifier and a value of one or more metrics characterizing a status of one or more operations that support the execution of the corresponding machine learning process. The at least one processor is further configured to execute the instructions to, based on the status data, generate and present, via the display unit, and for each of the plurality of machine learning processes, a first graphical representation of a first subset of the one or more metric values within a portion of a digital interface. The at least one processor is further configured to execute the instructions to receive, via the input unit, input data indicative of a selection of one or the first graphical representation associated with a corresponding one of the plurality of machine learning processes. The at least one processor is further configured to, based on the input data, generate and present, via the display unit, a second graphical representation of a second subset of the one or more metric values associated with the corresponding machine learning process within an additional portion of the digital interface.

The details of one or more exemplary embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIGS. 1, 2A, 2B, and 3 are block diagrams illustrating portions of an exemplary computing environment, in accordance with some exemplary embodiments.

FIGS. 4A, 4B, and 4C are diagrams illustrating portions of an exemplary, interactive digital dashboard, in accordance with some exemplary embodiments; and

FIG. 5 is a flowchart of an exemplary process for generating and maintaining an interactive digital dashboard for trained machine learning and artificial intelligence processes, in accordance with some embodiments

Like reference numbers and designations in the various drawings indicate like elements.

### DETAILED DESCRIPTION

Today, many organizations, such as financial institutions, rely on a predicted output of machine learning and artificial intelligence processes to inform a variety of decisions and strategies. By way of example, a financial institution may obtain elements of predicted, customer-specific output generated through an application of one or more trained machine learning or artificial intelligence processes, and the obtained elements of predicted, customer-specific output may inform, among other things, customer-specific strategies for mitigating or managing risk, decisions related to a suspiciousness of certain activities performed by these existing and prospective customers, or collection strategies involving one or more existing customers of the financial institution. Further, in some examples, the financial institution may also rely on the elements of customer-specific predicted output to inform decisions associated with the provisioning of financial products or services to existing or prospective customers of the financial institution, decisions associated with a requested modification to a term of condition of a provisioned financial product or service, or decisions associated with a targeted marketing of products and services to existing and prospective customers.

Although the machine learning and artificial intelligence processes may be trained adaptively to predicted future occurrences of events involving customers of the financial institution during future temporal intervals, each of the trained machine learning and artificial intelligence processes may be associated with, and may predict an occurrence of a corresponding, distinct, target event during a corresponding, and distinct future temporal interval. By way of example, and to inform a customer-specific decision regarding a requested modification to a term or condition of a provisioned financial product (e.g., an unsecured credit product, etc.), a machine learning and artificial intelligence process may be trained to predict an occurrence of a particular default event of a predetermined duration during a future, twelve-month interval. In other examples, to inform a customer-specific decision regarding a targeted marketing of financial products and services, an additional machine learning and artificial intelligence process may be trained to predict an occurrence of a particular engagement event involving a customer and a corresponding financial product or service during an additional, or alternate, future temporal interval, such as a three-month interval.

In some instances, each of the trained machine learning and artificial intelligence processes may be associated with a corresponding, process-specific input datasets, each of which may include a plurality of sequentially ordered, process-specific input feature and corresponding, customer-specific feature values, and with corresponding process-specific schedules for a delivery of corresponding elements of predicted output to a computing system associated with corresponding business units of the financial institution. Further, each of the trained machine learning and artificial intelligence processes may also be associated with a plurality of sequentially implemented data-pipelining operations that, when implemented by one or more computing systems associated with, or operated by, the financial institution, facilitate a generation and ingestion of corresponding process-specific input datasets, and generation, validation, or transaction of the elements of predictive output, in accordance with the underlying, process-specific delivery schedule for the corresponding elements of the predicted output (for example, at an expected delivery time on a daily basis, a weekly basis, a bi-monthly basis, or on a monthly basis).

To facilitate a delivery of the process-specific elements of the predicted output in accordance with corresponding ones of the process-specific delivery schedules, the one or more computing systems associated with, or operated by, the financial institution may collectively execute one, or more, of the process-specific data pipelining operations described herein on a simultaneous, or overlapping basis, which may facilitate a simultaneous, or overlapping, execution of one or more of the trained machine learning or artificial intelligence processes. In some instances, one or more of the executed process-specific data pipelining operations may experience a failure or a delay (e.g., due to absence of elements of customer-specific data associated with a corresponding input dataset, due to a failure in a communications network interconnecting one or more distributed computing components, etc.), and the one or more computing systems of the financial institution may detect the failure or delay, and generate and transmit a notification to a device operable by a representative of the financial institution, such as an analyst device operable by an analyst. Although the analyst device may generate and provision programmatic instructions (e.g., based on corresponding input from the analyst) that the one or more computing systems of the financial institution to reinitiate the failed or delayed, process-specific data pipelining operation, the re-initiation of the process-specific data pipelining operation may result in a temporal delay in the delivery of the corresponding, customer-specific elements of the predicted output to the computing system of the corresponding business unit.

In some examples, absent a real-time detection of the failure or a delay in the process-specific data pipelining operation, and a real-time provisioning of a notification of the detected failure or delay to an analyst device, the resulting temporal delay may reduce any ability of the one or more computing systems of the financial institution to re-initiate failed or delayed data pipelining operation based on programmatic instructions received from the analyst device and while delivering the customer-specific elements of the predicted output to the computing system of the corresponding business unit in accordance with the delivery schedule and at, or before, an agreed-upon delivery time. Further, although notification processes may enable the one or more computing systems of the financial institution (or an application program, code engine or module, or other elements of code executable by the one or more computing systems) to perform operations that generate and transmit notifications (e.g., email messages, text messages, etc.) to a computing device or system of a predetermined set of recipients (including the analyst described herein), these notification processes often cause the computing systems or devices to presents these received notification sequentially within a digital interface (e.g., a digital interface of an email or messaging application, as banners on a home screen, etc.).

Certain of these existing notification processes may fail to provide any centralized platform that enables the analyst to visualize a current status of each of the multiple, executed trained machine learning or artificial intelligence processes, and corresponding ones of the process-specific data pipelining operations, much less that enables the analyst to determine an impact of a particular delay or failure (e.g., associated with a corresponding one of the executed, machine learning or artificial intelligence processes and the corresponding business unit) on the delivery schedule associated with the corresponding, process-specific elements of predicted output, or on delivery schedules associated with other simultaneously or contemporaneously executed machine learning or artificial intelligence processes. Further, the absence of a centralized platform may also render impractical any process for debugging a data pipelining or execution of one or more of the executed, machine learning or artificial intelligence processes, and for comparing an actual data-pipelining or execution time associated with one or more of the machine learning or artificial intelligence processes against corresponding “expected” times, and additionally, or alternatively, for identifying or mediating potential “choke points” that trigger a delay, or failure, of the data pipelining associated with or the execution of one or more discrete machine learning or artificial intelligence processes, or classes or types of machine learning or artificial intelligence processes.

In some examples, one or more computing systems associated with the financial institution (or one or more distributed computing components) may perform operations, described herein, to generate, and render for presentation at a computing system or device of an analyst, a digital interface, such as an interactive, digital dashboard, having interface elements that identify each of a machine learning or artificial intelligence processes executed by the one or more computing systems associated with the financial institution. The exemplary processes described herein may enable one or more computing systems associated with the financial institution to provide a graphical representation of not only a current status of each of machine learning or artificial intelligence processes, as well as historical data characterizing a success or failure in the data pipelining operations associated with each of the executed machine learning or artificial intelligence processes over one or more prior temporal intervals. Further, the generated dashboard may, upon presentation by the computing system or device of the analyst, also include one or more interface elements that provide a graphical representation of a relative frequency of one or more data-pipelining or process-execution errors across all executed machine learning or artificial intelligence processes during one or more temporal intervals, and further, that provide a graphical representation of an aggregate number of successful, or failed, process executions during a current and one or more prior temporal intervals.

Through these exemplary processes, the presentation of the aggregate and process-specific outcome data within the dashboard may enable an analyst to not only identify and mediate, in real-time, the potential choke points in the data pipelining associated with, and the execution of, one or more of the machine learning or artificial intelligence processes, but also enable a characterizing and improvement (e.g., via load-balancing) of an efficiency of the data-pipelining and execution processes performed by the one or more computing systems of the financial institution, and a determination of a predicted consumption of computational resources during data pipelining associated with, and an execution of, a new machine learning or artificial intelligence processes. Certain of these exemplary processes, which provide a centralized and interactive digital interface characterizing a current status of each of the multiple, executed trained machine learning or artificial intelligence processes, and corresponding ones of the process-specific data pipelining operations, and which identifies, in real-time on a time-evolving basis, delays or failures associated with one or more of the executed trained machine learning or artificial intelligence processes, or corresponding ones of the process-specific data pipelining operations, may be implemented in addition to, or as an alternate to, existing notification processes that generate and provision process- or operation-specific notifications of detected delays or failures to an analyst device for sequential presentation within one or more digital interfaces.

### A. Exemplary Computing Environments

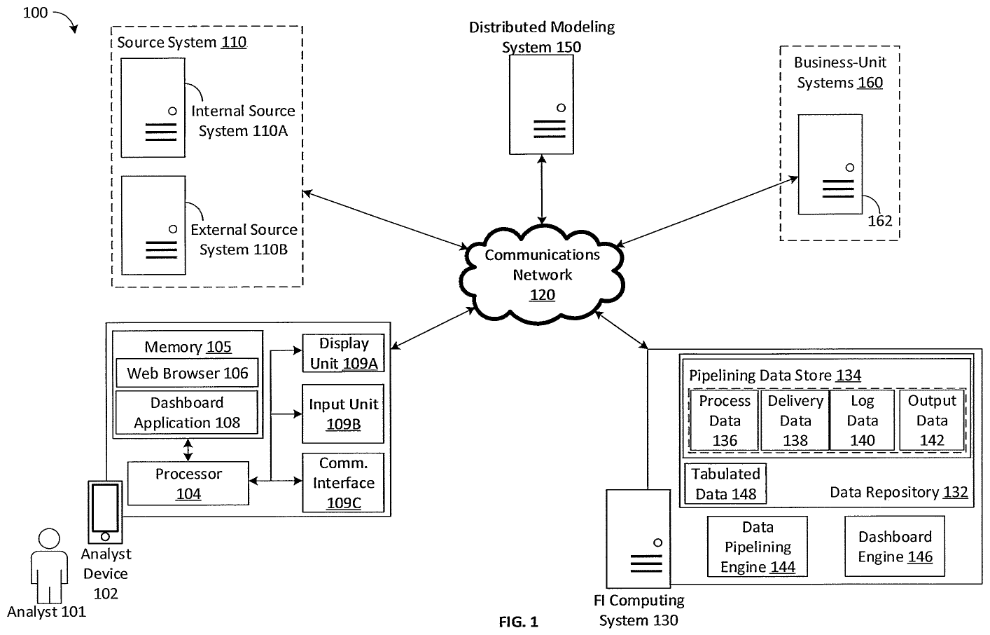

FIG. 1 illustrates an exemplary computing environment 100 that includes, among other things, one or more computing devices, such as an analyst device 102, and one or more computing systems, such as source systems 110, a financial institution (FI) system 130, distributed modeling system 150, and one or more business-unit systems 160, such as business-unit computing system 162. Each of the one or more computing devices and one or more computing systems may be operatively connected to, and interconnected across, one or more communications networks, such as communications network 120. Examples of communications network 120 include, but are not limited to, a wireless local area network (LAN) (e.g., a “Wi-Fi” network), a network utilizing radio-frequency (RF) communication protocols, a Near Field Communication (NFC) network, a wireless Metropolitan Area Network (MAN) connecting multiple wireless LANs, and a wide area network (WAN) (e.g., the Internet).

Analyst device 102 may include a computing device having one or more tangible, non-transitory memories, such as memory 105, that store data and/or software instructions, and one or more processors, such as, processor 104, configured to execute the software instructions. The one or more tangible, non-transitory memories may, in some aspects, store software applications, application modules, and other elements of code executable by the one or more processors, such as, but not limited to, an executable web browser 106 (e.g., Google Chrome™, Apple Safari™, etc.), and additionally or alternatively, an executable application associated with FI computing system 130 (e.g., dashboard application 108). In some instances, not illustrated in FIG. 1, memory 105 may also include one or more structured or unstructured data repositories or databases, and analyst device 102 may maintain one or more elements of device data and location data within the one or more structured or unstructured data repositories or databases. For example, the elements of device data may uniquely identify analyst device 102 within computing environment 100, and may include, but are not limited to, an Internet Protocol (IP) address assigned to analyst device 102 or a media access control (MAC) layer assigned to analyst device 102.

Analyst device 102 may also include a display unit 109A configured to present interface elements to a corresponding user and an input unit 109B configured to receive input from the user. For example, input unit 109B configured to receive input from the user in response to the interface elements presented through display unit 109A. By way of example, display unit 109A may include, but is not limited to, an LCD display unit or other appropriate type of display unit, and input unit 109B may include, but is not limited to, a keypad, keyboard, touchscreen, voice activated control technologies, or appropriate type of input unit. Further, in additional aspects (not illustrated in FIG. 1), the functionalities of display unit 109A and input unit 109B may be combined into a single device, such as, a pressure-sensitive touchscreen display unit that presents interface elements and receives input from the user of analyst device 102. Analyst device 102 may also include a communications interface 109C, such as a wireless transceiver device, coupled to processor 104 and configured by processor 104 to establish and maintain communications with communications network 120 via one or more communication protocols, such as WiFi®, Bluetooth®, NFC, a cellular communications protocol (e.g., LTE®, CDMA®, GSM®, etc.), or any other suitable communications protocol.

Examples of analyst device 102 may include, but not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), and any other type of computing device that may be configured to store data and software instructions, execute software instructions to perform operations, and/or display information on an interface device or unit, such as display unit 109A. In some instances, analyst device 102 may also establish communications with one or more additional computing systems or devices operating within computing environment 100 across a wired or wireless communications channel (via the communications interface 109C using any appropriate communications protocol). Further, a user, such as an analyst 101, may operate analyst device 102 and may do so to cause analyst device 102 to perform one or more exemplary processes described herein.

In some examples, source systems 110 (including internal source system 110A, and external source system 110B), FI computing system 130, distributed modeling system 150, and business-unit systems 160 (including computing system 162) may represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operations) in a single clock cycle. Further, each of source systems 110 (including internal source system 110A, and external source system 110B), FI computing system 130, distributed modeling system 150, and business-unit systems 160 (including computing system 162) may also include a communications interface, such as one or more wireless transceivers, coupled to the one or more processors for accommodating wired or wireless internet communication with other computing systems and devices operating within computing environment 100.

Further, in some instances, source systems 110 (including internal source system 110A, and external source system 110B), FI computing system 130, distributed modeling system 150, and business-unit systems 160 may each be incorporated into a respective, discrete computing system. In additional, or alternate, instances, one or more of source systems 110 (including internal source system 110A, and external source system 110B), FI computing system 130, distributed modeling system 150, and business-unit systems 160, may correspond to a distributed computing system having a plurality of interconnected, computing components distributed across an appropriate computing network, such as communications network 120 of FIG. 1. For example, FI computing system 130 and additional, or alternatively, distributed modeling system 150, may correspond, respectively, to a distributed or cloud-based computing cluster associated with, and maintained by, the financial institution, although in other examples, FI computing system 130 or distributed modeling system 150 may correspond, respectively, to a publicly accessible, distributed or cloud-based computing cluster, such as a computing cluster maintained by Microsoft Azure™, Amazon Web Services™, Google Cloud™, or another third-party provider.

For example, each of FI computing system 130 and distributed modeling system 150 may include a corresponding plurality of interconnected, distributed computing components, such as those described herein (not illustrated in FIG. 1A), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of FI computing system 130, and additionally, or alternatively, the distributed computing components of distributed modeling system 150 , may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle. Through an implementation of the parallelized, fault-tolerant distributed computing and analytical protocols described herein, the distributed computing components of FI computing system 130 may perform any of the exemplary processes described herein to, among other things, ingest elements of data associated with the customers of the financial institution, preprocess and store the ingested data elements within an accessible data repository (e.g., within a portion of a distributed file system, such as a Hadoop distributed file system (HDFS)), generate customer-specific input datasets suitable for ingestion by corresponding trained, machine learning or artificial intelligence processes based on an application of one of more extract, transform, and load (ETL) to the ingested data elements, and post-process and transform customer- specific elements of predicted output data into formats suitable for provisioning to corresponding ones of business-unit systems 160.

Further, and through an implementation of the parallelized, fault-tolerant distributed computing and analytical protocols described herein, the distributed components of distributed modeling system 150 may perform operations in parallel that not only train adaptively one or more machine learning or artificial intelligence processes using corresponding training and validation datasets, but also apply the trained machine learning or artificial intelligence processes to customer-specific input datasets and generate, in real time, elements of predicted output data. The implementation of the parallelized, fault-tolerant distributed computing and analytical protocols described herein across the one or more GPUs or TPUs included within the distributed components of FI computing system 130 and/or distributed modeling system 150 may, in some instances, accelerate the training, and the post-training deployment, of the machine-learning and artificial-intelligence process when compared to a training and deployment of the machine-learning and artificial-intelligence process across comparable clusters of CPUs capable of processing a single operation per clock cycle.

Referring back to FIG. 1, each of source systems 110 may maintain, within corresponding tangible, non-transitory memories, a data repository that includes confidential data associated with customers of the financial institution. For example, internal source system 110A may be associated with, or operated by, the financial institution, and may maintain, within the corresponding one or more tangible, non-transitory memories, a source data repository that includes one or more elements of customer profile data, account data, and transaction data that identify or characterize customers of the financial institution of FI computing system 130. Further, as illustrated in FIG. 1, external source system 1106 may also be associated with, or operated by, a third-party vendor, and maintain a source data repository that includes elements of third-party agency data. In some examples, the data records of third-party agency data may include reporting data associated with the customers of the financial institution of FI computing system 130, such as, but not limited to, elements of credit-bureau data associated with, and generated by, one or more credit bureaus. Further, each of the source systems 110 (e.g., internal source system 110A and external source system 1106) may perform operations that generate of obtain all, or a selected portion of the data records of customer profile data, account data, and transaction data, and reporting data associated with the customers, and that transmit the obtained portions as source data across communications network 120 to FI computing system 130 in real-time data and on a continuous streaming basis, on in batch form in accordance with a predetermined temporal schedule (e.g., on a daily basis, a monthly basis, etc.).

In some instances, one or more distributed components of FI computing system 130 may perform any of the exemplary processes described herein to execute one or more process-specific data pipelining operations associated with corresponding trained machine learning or artificial intelligence processes, which may facilitate a generation of customer- and process-specific input datasets. The one or more distributed components of FI computing system 130 may also perform any of the exemplary processes described herein that, in conjunction with distributed modeling system 150, apply each of the trained machine learning or artificial intelligence processes and generate corresponding, customer-specific elements of predicted output data, and that execute additional data pipelining operations to validate, post-process, and deliver the customer- and process-specific input datasets to corresponding ones of the business-unit systems 160, including computing system 162, in accordance with a delivery schedule established by corresponding ones of business-unit systems 160.

Further, in some instances, one or more distributed components of FI computing system 130 may perform any of the exemplary processes described herein to monitor an execution of each of the executed, process-specific data pipelining operations, and the application of the corresponding trained machine learning or artificial intelligence processes to the customer- and process-specific input data, and generate corresponding elements of log data that identify and characterize a successful initiation and completion of each of the executed data pipelining operations (including the application of the corresponding trained machine learning or artificial intelligence processes to the customer- and process-specific input) and any detected delays or failures. As described herein, and based on elements of the generated log data, the one or more distributed components of FI computing system 130 may perform operations that generate, and render for presentation at a computing system or device of an analyst, such as analyst device 102, an interactive, digital dashboard, having interface elements that identify each of the trained machine learning or artificial intelligence processes and provide a graphical representation of not only a current status of each of trained machine learning or artificial intelligence processes, and the corresponding data pipelining operations, but also of a relative frequency of one or more data-pipelining or process-execution errors, and of one or more successful process executions, during a current temporal interval and one or more prior temporal intervals.

To facilitate a performance of one or more of these exemplary processes, FI computing system 130 may maintain, within the one or more tangible, non-transitory memories, a data repository 132 that includes a pipelining data store 134 maintaining, among other things, elements of process data 136, delivery data 138, log data 140, and output data 142. By way of example, the elements of process data 136 may include, for each of the trained machine learning or artificial intelligence processes, a corresponding process identifier (e.g., an alphanumeric character string, such a process name, assigned by FI computing system 130). Further, the elements of process data 136 may also include, for each of the trained machine learning or artificial intelligence processes, corresponding elements of process parameter data, which specify value of one or more process parameters associated with the trained machine learning or artificial intelligence process, and corresponding elements of process input data, which characterize a composition of an input dataset for the trained machine learning or artificial intelligence process and identifies each of the discrete input features within the input data set, along with a sequence or position of the input feature values within the input data set.

Further, in some example, the elements of delivery data 138 may include, for each of the trained machine learning or artificial intelligence processes, an expected time or an expected interval associated with the delivery of customer- and process-specific output data to the corresponding business unit (e.g., a corresponding one of business-unit systems 160, etc.) and scheduling data characterizing, among other things a scheduled initiation time for data pipelining processes that support the execution of the machine learning or artificial intelligence processes (e.g., a time at which data pipelining engine 144 accesses source data, etc.). The elements of delivery data 138 may also include, for each of the trained machine learning or artificial intelligence processes, expected processing times for each of the exemplary data pipelining operations described herein, and each of the elements of delivery data, including the expected delivery time or delivery interval, the elements of scheduling data, and the expected processing time may be associated with a process identifier associated with the corresponding, trained machine learning or artificial intelligence process (e.g., the process name described herein).

In some instances, the elements of log data 140 may include, but are not limited to: (i) elements of a data-ingestion log that characterize a success, or failure, of a data-ingestion operation for each of the trained machine learning or artificial intelligence processes; (ii) elements of data-preparation log that characterize a success, or failure, of a data preparation operation for each of the trained machine learning or artificial intelligence processes; (iii) elements of execution log that characterize the success, or the failure, of an application of each of the trained machine learning or artificial intelligence processes to corresponding input datasets (e.g., a corresponding “execution” operation); (iv) elements of validation log that characterize the success or failure of a validation operation for each of the trained machine learning or artificial intelligence processes; and (v) elements of post-processing log that characterize, for each of the trained machine learning or artificial intelligence processes, a success, or failure, of not only a post-processing of the predictive output, but also of the provisioning of the transformed output to corresponding one of business-unit systems 160, such as computing system 162.

By way of example, each of the elements of data-ingestion log may be associated with an application of the data-ingestion operations described herein to a corresponding one of the Machine learning or artificial intelligence processes. In some instances, each of the elements of data-ingestion log may include a corresponding process identifier (e.g., as specified within process data 136) a starting time stamp (e.g., T_{START}) and an ending time stamp (T_{END}) for the data-ingestion operations, and additional data indicative of a successful outcome of the data-ingestion operations, or alternatively, a failure of the data-ingestion operations and a reason for that failure. Further, and by way of example, each of the elements of data-ingestion log may also include additional data indicative of either a programmatic initiation of the data-ingestion process or alternatively, or a manual initiation of the data-ingestion process (e.g., a re-ingestion initiated in response to a failure, etc.).

Further, each of the elements of the data-preparation log, execution log, validation log, and post-processing log maintained within log data 140 may also be associated with a corresponding one of the Machine learning or artificial intelligence processes. Additionally, each of the elements of data-preparation log, processing log, validation log, and post-processing log may also include, and may be associated with, a corresponding process identifier (e.g., the process name described herein), and as such, a corresponding one of the trained machine learning or artificial intelligence processes. Further, each of the process-specific elements of the data-preparation log, execution log, validation log, and post-processing log may also include corresponding, process-specific starting and ending time stamps, and additional data indicative of a successful outcome of a respective one of the data pipelining operations, or alternatively, a failure of a respective one of the data pipelining operations and a reason for that failure.

Further, in some examples, the elements of output data 142 may include, for each of the trained machine learning or artificial intelligence processes, a corresponding process identifier (e.g., the alphanumeric character string described herein), one or more customer- and process-specific elements of source data (e.g., ingested by FI computing system 130 through a performance of an of the exemplary data-ingestion operations described herein). The elements of output data 142 may include, for each of the trained machine learning or artificial intelligence processes, one or more process- and customer-specific input datasets and elements of ground-truth data (e.g., generated by FI computing system 130 through a performance of one or more of the exemplary data-preparation operations described herein), one or more process- and customer-specific elements of predicted output data (e.g., generated by distributed modeling system 150 through an application of a corresponding one of the trained machine learning and artificial intelligence processes to a corresponding process- and customer-specific input dataset), and one or more process- and customer-specific elements of transformed output data (e.g., generated by FI computing system 130 through a performance of one or more of the exemplary post-processing operations described herein).

Further, and to facilitate the performance of any of the exemplary processes described herein, FI computing system 130 may also maintain, within the one or more tangible, non-transitory memories, an application repository 143 that maintains, among other things, a data pipelining engine 144 and a dashboard engine 146, each of which may be executed by the one or more processors of FI computing system 130 (e.g., by one or more distributed components of FI computing system 130). In some examples, and upon execution by the one or more processors of FI computing system 130, data pipelining engine 144 may perform operations that, among other things, cause FI computing system 130 to establish a secure, programmatic channel of communications with one or more source systems 110, obtain one or more elements of source data from source systems 110 at regular, predetermined intervals (e.g., daily, weekly, monthly, etc.), and verify that the elements of source data are consistent with one or more temporal criteria (e.g., that the elements of source data are associated with a predetermined range of times or dates). Executed data pipelining engine 144 may perform operations, described herein, that store those verified elements of source data within a corresponding pipelining data store 134 (e.g., within portions of output data 142), and that generate elements of a data-ingestion log data that characterizes a success, or failure, of the data ingestion process and store the elements of the data-ingestion log data within log data 140 of pipelining data store 134.

Further, executed data pipelining engine 144 may also perform any of the exemplary processes described herein to access the elements of verified source data (e.g., as maintained within output data 142), and perform one or more extract, transform, and load (ETL) operations that transform elements of verified source data into corresponding, customer- and process-specific input datasets (e.g., in .CSV format) suitable for ingestion by the particular machine learning or artificial intelligence process. In some instances, each of the customer- and process-specific input datasets may be structured in accordance with the corresponding elements of process input data maintained within process data 136, and based on the corresponding elements of process input data, executed data pipelining engine 144 may also perform operations that tokenize all, or a selected portion, of verified source data, e.g., to mask elements of confidential source data consistent with one or more privacy or regulatory policies imposed on the financial institution. Executed data pipelining engine 144 may also store the customer- and process-specific input datasets within a corresponding portion of output data 142 of pipelining data store 134, e.g., in conjunction with the corresponding process identifier. Additionally, executed data pipelining engine 144 may also perform operations, described herein, to generate elements of a data-preparation log data that characterizes a success, or failure, of the data preparation process, and to store the elements of the data-preparation log data within log data 140 of pipelining data store 134.

Executed data pipelining engine 144 may also perform any of the exemplary processes described herein to access one or more of the customer- and process-specific input datasets and corresponding ones of the process identifiers (e.g., the alphanumeric character strings, etc.) maintained within output data 142 of pipelining data store 134. In some instances, executed data pipelining engine 144 may perform operations that cause FI computing system 130 to broadcast each of the customer- and process-specific input datasets and the corresponding process identifier (and in some instances, elements of prior inference data) across communications network 120 to one or more components of distributed modeling system 150. For example, an edge node of distributed modeling system 150 may receive the corresponding process identifiers and customer- and process-specific input datasets (and in some instances, the prior inference data), and for each of the process identifiers (e.g., that identify a particular one of the trained, machine learning and artificial intelligence processes), distributed modeling system 150 may perform operations (e.g., through parallel computations) that apply the particular machine learning or artificial intelligence process to corresponding ones of the customer- and process-specific input datasets based corresponding elements of the process parameter data, and that generate corresponding customer- and process-specific elements of predicted output data. The one or more components of distributed modeling system 150 may transmit each of the process identifiers and the corresponding customer- and process-specific elements of predicted output data across communications network 120 to FI computing system 130, either alone or in conjunction with one or more process-specific error messages indicative of failure of the particular machine learning or artificial intelligence process at inferencing or ground-truth validation.

Executed data pipelining engine 144 may receive each of the process identifiers, the corresponding customer- and process-specific elements of predicted output data, and in some instances, the process-specific errors messages from distributed modeling system 150, and may perform operations that store the process identifiers and the corresponding customer- and process-specific elements of predicted output data (and the process-specific errors messages) within a portion of output data 142 of pipelining data store 134. Further, based on the customer- and process-specific elements of predictive output data and additionally, or alternatively, the process-specific error messages, executed data pipelining engine 144 may generate elements of a processing log data that characterize the success, or the failure, of the application of corresponding ones of the trained machine learning or artificial intelligence processes to the customer- and process-specific input datasets, and that store the elements of the processing log data within log data 140, and a corresponding one of the process identifiers, within log data 140 of pipelining data store 134.

In some examples, executed data pipelining engine 144 may access the customer- and process-specific elements of predictive output associated with each of the process identifiers (e.g., and with corresponding ones of the trained machine learning or artificial intelligence processes), and perform operations that validate all or a selected portion of the elements of predictive output data. For instance, executed data pipelining engine 144 may validate a customer- and process-specific element of predicted output data based on determination that a format, structure, or composition of that element corresponds to an expected format, structure, or composition. Executed data pipelining engine 144 may also perform operations that generate one or more elements of a validation log, which characterizes the success or failure of the validation process applied to each of the customer- and process-specific elements of predicted output data, and may store each element of the validation log, and corresponding ones of the process identifiers, within log data 140 of pipelining data store 134

By way of example, and for a particular one of the trained, machine learning or artificial intelligence processes, the expected format, structure, or composition may specify that a corresponding element of predicted output data include a numerical value characterized by a predetermined range of values, and when a corresponding element of predicted output data includes a numerical value disposed within the predetermined range of values, executed data pipelining engine 144 may validate the corresponding element of predicted output data and generate an element of the validation log indicative of the successful validation of that elements. In other examples, and for an additional one of the trained, machine learning or artificial intelligence processes, the expected format, structure, or composition may specify that a corresponding element of predicted output data include an alphanumeric character string (e.g., a category) characterized a predetermined set of candidate values (e.g., candidate categories), and when the corresponding element of predicted output data includes one of the candidate values, executed data pipelining engine 144 may validate the corresponding element of predicted output data and generate an additional element of the validation log indicative of the successful validation of that elements.

Based on a successful validation of a particular one of the customer- and process-specific predicted output data associated with a corresponding one of the trained, machine learning or artificial intelligence processes, executed data pipelining engine 144 may perform any of the exemplary processes described herein to transform the customer-and process-specific element of predictive output data into a format or structure consumable, and interpretable by one or more application programs executed by a computing system of the corresponding business-unit, such as, but not limited to, computing system 162 of business-unit systems 160), and to provision elements of transformed output to the computing system of the corresponding business-unit, e.g., in accordance with respective ones of the delivery schedules. Additionally, executed data pipelining engine 144 may perform operations that store the customer- and process-specific elements of transformed output within a corresponding portion of output data 142 within pipelining data store 134. In some examples, executed data pipelining engine 144 may also perform operations that, for each of the customer- and process-specific predicted output data, generate one or more elements of a post-processing log that characterize a success, or failure, of the post-processing operations, as well as of the provisioning of the corresponding elements of transformed output to the computing system of the corresponding business-unit, and that store the elements of the post- processing log data, and a corresponding one of the process identifiers, within a portion of log data 140 of pipelining data store 134.

Further, and upon execution by the one or more processors of FI computing system 130, dashboard engine 146 may perform any of the exemplary processes described herein to parse the obtained elements of process data 136, delivery data 138, and log data 140, and to generate values of one or more metrics that characterize a success, failure, or delay (e.g., based on a comparison of actual and expected times) in an execution of one or more of the data-pipelining operations described herein, on both an aggregate basis across the trained machine learning or artificial intelligence processes during one or more temporal intervals, and on a process-specific basis during the one or more temporal intervals. Executed data pipelining engine 144 may package all, or a selected portion, of the generated metric values into corresponding portions of tabulated data 148, which executed data pipelining engine 144 may store within a corresponding portion of pipelining data store 134.

For example, tabulated data 148 may include elements of process-specific tabular data identifying and characterizing one or more of the data pipelining operations associated with each of the trained machine learning or artificial intelligence processes during a current temporal interval and additionally, or alternatively during one or more prior temporal intervals. For example, each element of process-specific tabular data may be associated with a corresponding one of the trained machine learning or artificial intelligence processes, and may include a corresponding process identifier, such as those described herein. Each of the elements of process-specific tabular data may also include, for the corresponding one of the trained machine learning or artificial intelligence processes, status data characterizing a corresponding status one or more of the exemplary data-pipelining operations described herein (e.g., complete, failed, delayed, or idle), and additional data characterizing a rate of operational success, delay, or failure of these executed data pipelining operations during the current temporal interval or across one or more of the prior temporal intervals (e.g., percentage of times an executed data pipelining operations resulted in successful completion, delay, or failure, etc.).

For example, and based on the parsed elements of log data 140, executed data pipelining engine 144 may compute the rate of operational success, delay, or failure during the current temporal interval, or across one or more of the prior temporal intervals, for each of the trained, machine learning or artificial intelligence processes, and may package the computed completion, delay, or failure rates into the elements of process-specific tabular data associated with corresponding ones of the trained, machine learning or artificial intelligence processes. Further, in some examples, and for each of the failures of the data pipelining operations associated with a corresponding one of the trained, machine learning or artificial intelligence processes, executed dashboard engine 146 may obtain data (e.g., from log data 140) identifying a cause for that failure, and determine a contribution (e.g., a percentage) of each of the failure causes to the total number of data-pipelining failures specified within log data 140 for the corresponding one of the trained, machine learning or artificial intelligence processes. Executed data pipelining engine 144 may package each of the determined contributions (e.g., the percentages) and the data identify the associated failure cause within the elements of process-specific tabular data associated with the corresponding one of the trained, machine learning or artificial intelligence processes.

The elements of process-specific tabular data may also identify a number of manual re-initiations of a data ingestion operation associated with corresponding ones of the trained machine learning or artificial intelligence processes during the current temporal interval, or across one or more prior temporal interval. By way of example, and as described herein, each of the manual re-initiations may be associated with a corresponding failure of a data ingestion operation (e.g., due to an absence of elements of customer data, etc.), and with a receipt of programmatic re-initiation instructions generated by an application program executed by an analyst computing system or device, e.g., by analyst device 102 based on input received from analyst 101.

In some instances, executed dashboard engine 146 may further process the elements of process-specific tabular data associated with the current interval, or with one or more prior temporal intervals, and generate corresponding elements of aggregated tabular data, which executed dashboard engine 146 may package into corresponding portions of tabulated data 148. By way of example, the elements of aggregated tabular data may include aggregated values of the rates of operational success, delay, or failure for corresponding ones of the executed data operations across all, or a selected subset, of the trained, machine learning or artificial intelligence processes during the current temporal interval or during one or more of the prior temporal intervals. Further, in some examples, (e.g., percentage of times an executed data pipelining operations resulted in successful completion, delay, or failure, etc.). The elements of aggregated tabular data may also include aggregated values of the determined contributions (e.g., the percentages) of each of the failure causes to the total number of data-pipelining failures across all, or a selected subset, of the trained, machine learning or artificial intelligence processes during the current temporal interval or during one or more of the prior temporal intervals, and additionally, or alternatively, aggregated values of the numbers of manual re-initiations of the data ingestion operations associated with all, or a selected subset, of the trained, machine learning or artificial intelligence processes during the current temporal interval or during one or more of the prior temporal intervals.

Further, tabulated data 148 may also include one or more elements of calendar data, for each of the data pipelining operations associated with each of the trained, machine learning or artificial intelligence processes, temporal data characterizing a scheduled time or date of programmatic execution by data pipelining engine 144 during a current temporal interval, or during one or more prior temporal intervals. For example, executed dashboard engine 146. By way of example, executed dashboard engine 146 may parse the elements of delivery data 138 and for each of the trained, machine learning or artificial intelligence processes (and corresponding process identifiers), obtain portions of the temporal data that identifies and specifies the time and date of the scheduled execution of each of the associated data pipelining operations, and package the portions of the temporal data, information identifying the data pipelining operations, and the corresponding process identifier into the elements of calendar data. Additionally, in some examples, executed dashboard engine 146 may also parse the elements of log data 140 and obtain further temporal data characterizing a time and date of each manual re-initiation of the data-pipelining process, and to package the additional temporal data, information identifying the manual re-initiation (e.g., identifying a corresponding one of the data pipelining operations), and the corresponding process identifier into the elements of calendar data. As described herein, each of the element of calendar data may be associated with a corresponding one of the trained machine learning or artificial intelligence processes, and may include a corresponding one of the process identifiers, which may link that each of the elements of calendar data to a corresponding element of process-specific tabular data.

In some instances, executed dashboard engine 146 may perform any of the exemplary processes described herein to access and process the elements of tabulated data, and generate corresponding interface elements of a digital interface (e.g., an interactive, digital dashboard) that, when rendered for presentation by an application program executed by analyst device 102 (e.g., web browser 106 or dashboard application 108, etc.), establish a centralized digital platform that enables analyst 101 to visualize, in real-time, a current status (e.g., success, failure, and/or delay) of a delivery of customer-and process-specific elements of predicted output data associated with all, or a selected subset and a contribution of one or more of the data pipelining operations to the delivery of customer- and process-specific elements of predicted output data during a current temporal interval and during one or more prior temporal intervals. Further, when rendered for presentation by an application program executed by analyst device 102, the generated interface elements may also enable analyst 101 to determine, in real-time, an impact of a particular delay or failure of a data pipelining operation associated with a corresponding one of the trained, machine learning or artificial intelligence processes on not the delivery schedule associated with the trained, machine learning or artificial intelligence process, but also on the delivery scheduled associated with other trained, machine learning or artificial intelligence processes simultaneously or contemporaneously executed by the distributed components of FI computing system 130 or distributed modeling system 150. Through a performance of certain of these exemplary processes, one or more application programs executed by analyst device 102 to generate and provision programmatic instructions that cause executed data pipelining engine 144 to minimize an impact of the particular failure or delay by re-initiating the data pipelining operation and additionally, or alternatively, performing operations that balance a computational load across the one or more distributed components of FI computing system 130.

### B. Exemplary Processes for Generating and Maintaining Interactive, digital Dashboards for Trained Machine Learning or Artificial Intelligence Processes

In some examples, one or more distributed components of FI computing system 130 may perform operations, described herein, to implement one or more discrete, process-specific data pipelining operations that facilitate a simultaneous, or overlapping, execution of multiple of trained machine learning or artificial intelligence processes on behalf of corresponding business units in accordance with a process-specific pipelining schedule, and that deliver corresponding transformed elements of predictive output to each of the business units in accordance with a process-specific delivery schedule. Further, and through an implementation of any of the exemplary processes described herein, the one or more distributed components of FI computing system 130 my monitor a success, delay, or alternatively, a failure of each of the discrete, process-specific data pipelining operations, and to generate and maintain elements of data (e.g., within portions of log data 140) that characterize an implementation of each of the process-specific data pipelining operations and identify a corresponding success, delay, or failure of corresponding one of the process-specific data pipelining operations, including, but not limited to, a success, delay, or failure of an application of corresponding ones of the trained machine-learning or artificial-intelligence processes to process-specific input datasets by the components of distributed modeling system 150, and the success, delay, or failure of the delivery of transformed elements of predictive output to corresponding ones of the business units in accordance with a process-specific delivery schedule.

Further, the one or more distributed components of FI computing system 130 may also perform operations, described herein, to generate, and render for presentation at a computing system or device of an analyst (e.g., analyst device 102 of FIG. 1), a digital interface, such as an interactive, digital dashboard, having interface elements that identify each of the machine learning or artificial intelligence processes, further, that provide a graphical representation of not only a current status of each of machine learning or artificial intelligence processes, but also historical data characterizing a success, delay, or failure of each of discrete, process-specific data pipelining operations associated with each of the machine learning or artificial intelligence processes during a current temporal interval and over one or more prior temporal intervals. The interactive, digital dashboard may, upon presentation by analyst device 102, also provide a graphical representation of a relative frequency of one or more data-pipelining or process-execution errors across all executed machine learning or artificial intelligence processes during one or more temporal intervals, and in some instances, a graphical representation of an aggregate number of successful, delayed, or failed, process-specific data pipelining operations during the current temporal interval and across and one or more prior temporal intervals.

Through these exemplary processes, the presentation of the aggregate and process-specific data characterizing the data pipelining operations associated with each, or a subset of, the trained machine learning or artificial intelligence processes within the interactive, digital dashboard may enable an analyst to not only identify and mediate, in real-time, the potential choke points in the data pipelining associated with, and the execution of, one or more of the machine learning or artificial intelligence processes, but also enable a characterizing and improvement (e.g., via load-balancing) of an efficiency of the data-pipelining and execution processes performed by the one or more computing systems of the financial institution, and a determination of a predicted consumption of computational resources during data pipelining associated with, and an execution of, a new machine learning or artificial intelligence processes. Certain of these exemplary processes, which provide a centralized and interactive digital interface characterizing a current status of each of the multiple, executed trained machine learning or artificial intelligence processes, and corresponding ones of the process-specific data pipelining operations, and which identifies, in real-time on a time-evolving basis, delays or failures associated with one or more of the executed trained machine learning or artificial intelligence processes, or corresponding ones of the process-specific data pipelining operations, may be implemented in addition to, or as an alternate to, existing notification processes that generate and provision process- or operation-specific notifications of detected delays or failures to an analyst device for sequential presentation within one or more digital interfaces.

By way of example, the trained machine learning or artificial intelligence processes may include a gradient-boosted, decision-tree process (e.g., an XGBoost process, etc.) trained to generate elements of predicted output characterizing a likelihood of an occurrence of an event involving corresponding customers of the financial institution during a future temporal interval of predetermined duration (e.g., one month, three months, one year, etc.). As described herein, the trained gradient-boosted, decision-tree process may be associated with a corresponding process identifier (e.g., an alphanumeric character string assigned to the trained, gradient-boosted decision tree process by FI computing system 130, etc.), one or more elements of process parameter data that include values of one or more process parameters of the trained, gradient-boosted decision-tree process, and one or more elements of process input data that specify a composition of an input dataset associated with the trained, gradient-boosted decision-tree process.

The process parameters may include, but are not limited to, a learning rate associated with the trained, gradient-boosted, decision-tree process, a number of discrete decision trees included within the trained, gradient-boosted, decision-tree process (e.g., the “n_estimator” for the trained, gradient-boosted, decision-tree process), a tree depth characterizing a depth of each of the discrete decision trees included within the trained, gradient-boosted, decision-tree process, a minimum number of observations in terminal nodes of the decision trees, and/or values of one or more hyperparameters that reduce potential process overfitting (e.g., regularization of pseudo-regularization hyperparameters). Further, the elements of process input data may also identify elements of customer-specific data (e.g., feature values) included within the input dataset (e.g., the candidate feature values described herein), a sequence or position of these feature values within the input dataset, and in some instances, one or more temporal criteria associated with the input dataset and the trained, gradient-boosted decision-tree process. By way of example, and as described herein, the one or more distributed components of FI computing system 130 may perform operations that generate each of the customer-specific input datasets based on elements of internal and external source data maintained by respective ones of internal source system 110A and external source system 110B, and the one or more temporal criteria may establish a temporal extraction interval for the elements of internal and external source data.

The one or more distributed components of FI computing system 130 may also perform operations, described herein, that provision the customer-specific elements of predicted output to a corresponding one of business-unit systems 160, such as business-unit computing system 162, in accordance with a predetermined delivery schedule. By way of example, the predetermined delivery schedule may establish a daily delivery time of 10:00 a.m. for the customer-specific elements of predicted output of the trained, gradient-boosted, decision-tree process. Further, the data pipelining operations that facilitate a generation of the customer-specific input datasets in accordance with the elements of process input data, an application of the trained, gradient-boosted, decision-tree process to each of the customer-specific input datasets, and post-processes and delivery of the customer-specific elements of predicted output to business-unit computing system 162 may be associated with an expected, end-to-end processing time of five hours.

By way of example, to facilitate the delivery of the customer-specific elements of predicted output to business-unit computing system 162 at, or in advance of the delivery time, one or more of the distributed components of FI computing system 130 may initiate the data pipelining operations described herein at 3:30 a.m. on a daily basis, and absent delays or failures, the one or more distributed components FI computing system 130 will complete the data pipelining operations and provision the customer-specific elements of predicted output to business-unit computing system 162 by 8:30 a.m. on a daily basis. In some instances, the one or more distributed components of FI computing system 130 may maintain, within a corresponding data repository (e.g., within delivery data 138 of pipelining data store 134), elements of scheduling data that specify, for the trained, gradient-boosted, decision-tree process, the daily delivery time of 10:00 a.m., the end-to-end processing time for the data pipelining operations associated with the trained, gradient-boosted, decision-tree process (e.g., five hours), the scheduled daily initiation time of 3:30 a.m. for the data pipelining operations, and additionally, or alternatively, data characterizing an expected processing time for each of the discrete data pipelining operations.

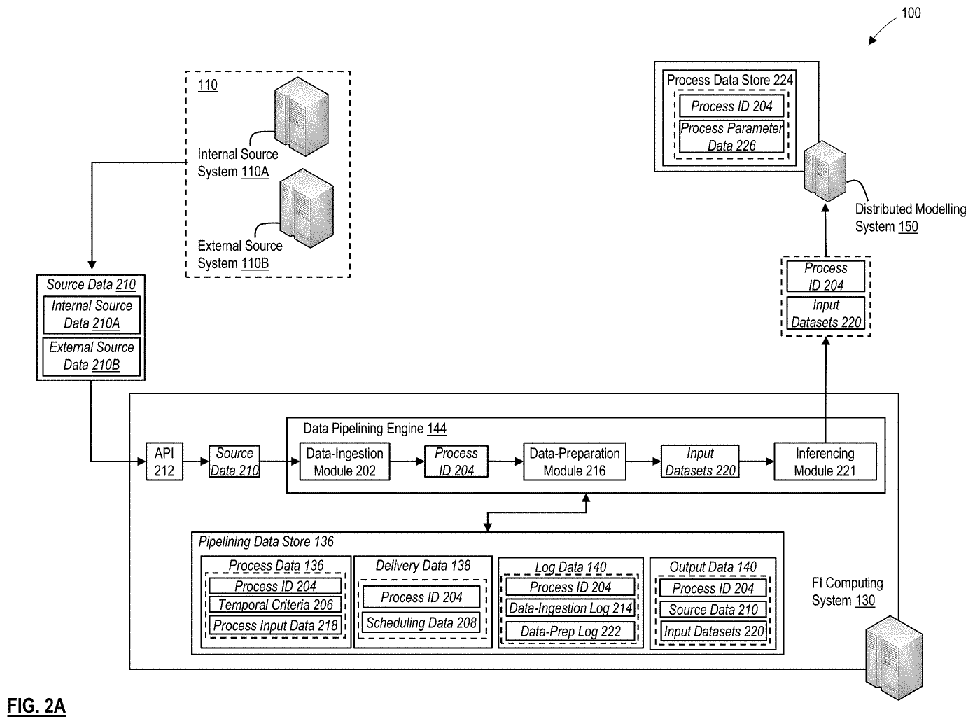

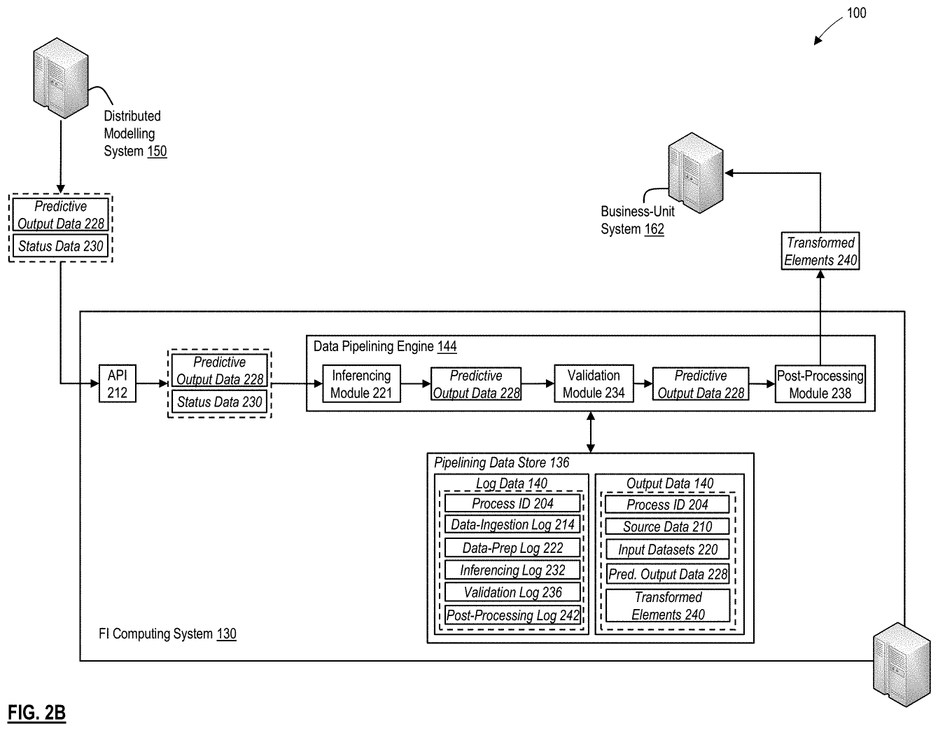

Referring to FIG. 2A, one or more processors of FI computing system 130 (e.g., one or more of the distributed components described herein) may execute data pipelining engine 144, and a data ingestion module 202 of executed data pipelining engine 144 may perform operation that access process data 136 of pipelining data store 134, and obtain a process identifier 204 associated with the trained, gradient-boosted, decision-tree process (e.g., an alphanumeric character string, such as a process name, etc.). Based on process identifier 204, executed data ingestion module 202 may perform operations that obtain one or more temporal criteria 206 associated with the trained, gradient-boosted, decision-tree process (e.g., the temporal extraction interval, etc.) and further, that access delivery data 138 of pipelining data store 134 and obtain one or more elements of scheduling data 208 associated with process identifier 204. As described herein, the elements of scheduling data 208 may specify, for the trained, gradient-boosted, decision-tree process, the daily delivery time of 10:00 a.m., the end-to-end processing time for the corresponding data pipelining operations (e.g., five hours), the scheduled daily initiation time of 3:30 a.m. for the data pipelining operations, and additionally, or alternatively, the data characterizing an expected processing time for each of the discrete data pipelining operations.

In some instances, and in accordance with the scheduled daily initiation time of (e.g., at 3:30 a.m.), executed data ingestion module 202 may perform operations that cause FI computing system 130 to establish a secure, programmatic channel of communications with one or more source systems 110, obtain one or more elements of source data from source systems 110, such as internal source system 110A and external source system 110B, and to request and receive elements of source data 210 from corresponding ones of internal source system 110A and external source system 110B across the secure, programmatic channel of communications. By way of example, as illustrated in FIG. 2A, a programmatic interface, such as application programming interface (API) 212 may receive the elements of source data 210, including internal source data 210A and external source data 210B, from corresponding ones of internal source system 110A and external source system 110B, and API 212 may route the received elements of source data 210 to executed data ingestion module 202.

By way of example, the elements of source data 210 may identify and characterize all, or a predetermined or selected subset, of the customers of the financial institution, and may characterize interactions between the customers and the financial institution, and the between the customer and other financial institutions, regulatory entities, governmental entities, or judicial entities across one or more temporal intervals. For example, the elements of source data 210 may include one or more elements of internal source data 210A maintained by internal source system 110A, and the elements of internal source data 210A may include, but are not limited to, elements of customer profile data, account data, transaction data, delinquency data, or other information identifying and characterizing corresponding customers of the financial institution. The elements of source data 210 may also include one or more elements of external source data 210B maintained by external source system 110B, and examples of the elements of external source data 210B include, but are not limited to, elements of credit-bureau data generated or maintained on behalf of corresponding customers by a corresponding reporting agency (e.g., a customer-specific credit score, a customer-specific number of credit inquiries, etc.). The disclosed embodiments are, however, not limited to these exemplary elements of internal and external source data, and in other examples, source data 210 may include any additional or alternate elements that identify or characterize the customers of the financial institution or the interactions of these customers with the financial institution or with other financial institutions.

In some instances, executed data-ingestion module 202 may also perform operations that verify the elements of source data 210 are consistent with all, or a selected subset, of temporal criteria 206. By way of example, temporal criteria 206 may specify a predetermined, temporal extraction interval, which may identify a predetermined range of times or dates, and executed data-ingestion module 202 may perform operations that, for each of the element of source data 210 (including internal source data 210A and external source data 210B) determine whether the element of source data 210 is associated with a corresponding time or date (e.g., a time or date at which a respective one of internal source system 110A or external source system 110B generated or stored the element of source data 210, etc.) falls within the predetermined range of times or dates. Based on a determination that the corresponding time or date falls within the predetermined range of times or dates, executed data-ingestion module 202 may verify a consistency of that element of source data 210, and store that element of source data 210 within a corresponding portion of pipelining data store 134, e.g., within a portion of output data 142 in conjunction with process identifier 204. Alternatively, if executed data-ingestion module 202 were to determine that the corresponding time or date falls outside the predetermined range of times or dates, executed data-ingestion module 202 may deem that element of source data 210 unsuitable for further process, and may perform operations that discard that element of source data 210.

Executed data-ingestion module 202 may perform any of the exemplary processes described herein to verify a consistency of each additional, or alternate, element of source data 210 with temporal criteria 206. Upon completion of these exemplary verification processes, executed data-ingestion module 202 may also perform operations that generate elements of a data-ingestion log 214 characterizing a success, or alternatively, a failure, of the data-ingestion operations described herein, and that store the elements of the data-ingestion log 214 within a portion of pipelining data store 134, e.g., within log data 140 in conjunction with process identifier 204. In some instances, the exemplary data-ingestion operations described herein may be completed successfully when executed data-ingestion module 202 ingests and verifies a predetermined, threshold volume of customer-specific elements of source data 210, or ingests and verifies customer-specific elements of source data 210 having a predetermined composition, and the elements of the data-ingestion log 214 may include status data that characterizes the success or failure of the data-ingestion operations associated with the trained, gradient-boosted, decision-tree process and temporal data that identifies a time or date of a completion of the data-ingestion operations.

As illustrated in FIG. 2A, and responsive to a successful completion of the data-ingestion operations associated with the trained, gradient-boosted, decision-tree process, executed data-ingestion module 202 may provide process identifier 204 as an input to a data-preparation module 216 of executed data pipelining engine 144. In some instances, executed data-preparation module 216 may perform operations that, based on process identifier 204, access the elements of verified source data 210 maintained within output data 142 of pipelining data store 134 and access elements of process input data 218 associated with the trained, gradient-boosted, decision-tree process, which may be maintained within process data 136 of pipelining data store 134. As described herein, the elements of process input data 218 may identify each of the feature values included within a customer-specific input dataset associated with the trained, gradient-boosted, decision-tree process, and a position or sequence of each of these feature values within the customer-specific input dataset.

Executed data-preparation module 216 may perform operations that apply one or more perform various extract, transform, and load (ETL) operations to the customer-specific elements of verified source data 210, and based on the application of the one or more ETL operations to the customer-specific elements of verified source data 210, executed data-preparation module 216 may generate one or more customer-specific input datasets 220 having compositions that are consistent with the elements of process input data 218 and that are suitable for ingestion by the trained, gradient-boosted, decision-tree process. In some instances, and prior to the generation of customer-specific input datasets 220, executed data-preparation module 216 may also perform operations that tokenize all, or a selected portion, of verified source data 210, e.g., to mask elements of confidential source data 210 consistent with one or more privacy or regulatory policies imposed on the financial institution. Executed data-preparation module 216 may also store each of customer-specific input datasets 220 within a portion of pipelining data store 134, e.g., within output data 142 in conjunction with process identifier 204. Additionally, executed data-preparation module 216 may generate elements of a data-preparation log 222 that include, but are not limited to, status data characterizing a success or failure of the data-preparation operations associated with the trained, gradient-boosted, decision-tree process and temporal data that identifies a time or date of a completion of the data-preparation operations. Executed data-preparation module 216 may perform operations that store the elements of the data-preparation log 222 within log data 140 of pipelining data store 134, e.g., in conjunction with process identifier 204.

In some instances, and responsive to a successful completion of the data-preparation operations associated with the trained, gradient-boosted, decision-tree process, executed data-preparation module 216 may provide process identifier 204 and customer-specific input datasets 220 as inputs to an inferencing module 221 of executed data pipelining engine 144. As illustrated in FIG. 2A, executed inferencing module 221 may perform operations that cause FI computing system 130 to broadcast process identifier 204 and each of customer-specific input datasets 220 (and in some instances, elements of prior inferencing data associated with the trained, gradient-boosted, decision-tree process) across communications network 120 to one or more components of distributed modeling system 150. By way of example, an edge node of distributed modeling system 150 may receive process identifier 204 and each of customer-specific input datasets 220, and may perform operations that access a process data store 224 and access one or more elements of process parameter data 226 associated with process identifier 204 and as such, with the trained, gradient-boosted, decision-tree process.

By way of example, the one or more distributed components of distributed modeling system 150 may maintain process data store 224 within a portion of a distributed file system, such as a Hadoop distributed file system (HDFS)), and elements of process parameter data 226 may specify a value of one or more process parameters of the trained, gradient-boosted, decision-tree process, such as, but not limited to, the exemplary process parameter values described herein. Further, and based on the elements of process parameter data 226, and through an implementation of one or more of the exemplary parallelized, fault-tolerant distributed computing and analytical processes described herein, the distributed components of distributed modeling system 150 may perform operations that establish a plurality of nodes and a plurality of decision trees for the trained, gradient-boosted, decision-tree process, each of which receive, as inputs (e.g., “ingest”), corresponding elements of customer-specific input datasets 220. Based on the ingestion of each of customer-specific input datasets 220 by the established nodes and decision trees of the trained, gradient-boosted, decision-tree process, and through an implementation of one or more of the exemplary parallelized, fault-tolerant distributed computing and analytical processes described herein, the distributed components of distributed modeling system 150 may perform operations that apply the trained, gradient-boosted, decision-tree process to each of customer-specific input datasets 220, as illustrated in FIG. 2B.

Referring to FIG. 2B, and based on the application of the trained, gradient-boosted, decision-tree process to each of customer-specific input datasets 220, the distributed components of distributed modeling system 150 may also perform operations that generate a customer-specific element of predicted output data 228 associated with a corresponding one of customer-specific input datasets 220. Further, one or more of the distributed components of distributed modeling system 150 may also generate status data 230, which may be indicative of a successful completion of the inferencing operations described herein, and one or more of the distributed components of distributed modeling system 150, such as the edge node described herein, may transmit the customer-specific elements of predicted output data 228 and status data 230 across communications network 120 to FI computing system 130.

In some instances, API 212 may receive the customer-specific elements of predicted output data 228 and status data 230, and may route the customer-specific elements of predicted output data 228 and status data 230 to executed inferencing module 221, which may perform operations that store the customer-specific elements of predicted output data 228 within a corresponding portion of pipelining data store 134, e.g., within output data 142 in conjunction with process identifier 204. Based on the customer-specific elements of predicted output data 228 and on status data 230, executed inferencing module 221 may generate corresponding elements of an inferencing log 232 that characterize the successful application of the trained, gradient-boosted, decision-tree process to each of customer-specific input datasets 220, and executed Inferencing module 221 may perform operations that store the elements of the inferencing log 232 within a portion of log data 140, e.g., as maintained within pipelining data store 134.

In some instances, the one or more distributed components of distributed modeling system 150 may fail to successfully apply the trained, gradient-boosted, decision-tree process to each of customer-specific input datasets 220 and as such, may experience a failure in the exemplary inferencing operations described herein. The inferencing operations may, for example, experience a hardware or a communications failure (e.g., a failure of the edge node, a communications failure between the distributed components, etc.), or the failure may be associated with an absence of process parameter data associated with process identifier 204 and the trained, gradient-boosted, decision-tree process. Based on the failure in the inferencing operations, the one or more distributed components of distributed modeling system 150 may perform operations (not illustrated in FIG. 2B) that generate elements of error data identifying and characterizing the failure in the inferencing operations, and that transmit the elements of error data across communications network 120 to FI computing system 130 (e.g., without any elements of predicted output data). API 212 may receive and route the elements of error data to executed inferencing module 221, which may generate corresponding elements of inferencing log 232 that characterizes the failed application of the trained, gradient-boosted, decision-tree process to customer-specific input datasets 220.

Referring back to FIG. 2B, and based on the successful application of the trained, gradient-boosted, decision-tree process to customer-specific input datasets 220, executed inferencing module 221 may provision the customer-specific elements of predicted output data 228 as an input to a validation module 234 of executed data pipelining engine 144, which may perform any of the exemplary validation operations described herein to validate all or a selected portion of customer-specific elements of predicted output data 228. For example, executed validation module 234 may validate one or more of the customer-specific elements of predicted output data 228 based on determination that a format, structure, or composition of these customer-specific elements corresponds to an expected format, structure, or composition. Based on a successful validation of the customer-specific elements of predicted output data 228, executed validation module 234 may also generate one or more elements of a validation log 236, which characterizes the success of the validation operations, and may store the one or more elements of validation log 236 within log data 140 of pipelining data store 134, e.g., in conjunction with process identifier 204. In other instances, based on a determined failure of the validation operations applied to at a subset of the customer-specific elements of predicted output data 228 (e.g., based on a determined inconsistency between the format, structure, or composition of the subset of the customer-specific elements and the expected format, structure, or composition), executed validation module 234 may discard at least the subset of the customer-specific elements of predicted output data 228, and generate additional elements of validation log 236 that characterize the determined failure success of the validation operations.

Based on a successful validation of the customer-specific elements of predicted output data 228, executed validation module 234 may route the customer-specific elements of predicted output data 228 to a post-processing module 238, which may perform any of the exemplary post-processing operations described herein that transform the customer-specific elements of predicted output data 228 into a format or structure consumable, and interpretable. by one or more application programs executed by business-unit computing system 162. By way of example, each of the customer-specific elements of predicted output data 228 may include a numerical value indicative of a predicted likelihood of an occurrence of a target event during a corresponding customer during a future temporal interval, and executed post-processing module 238 may perform post-processing operations that sort the customer-specific elements of predicted output data 228 in accordance with the numerical value, that associate each of the sorted numerical values with a corresponding customer identifier, and additionally, or alternatively, that filter the sorted numerical values in accordance with one or more filtration criteria.

In some instances, executed post-processing module 238 may perform operations that transmit the transformed elements of predicted output data (e.g., transformed elements 240 of predicted output data of FIG. 2B) across communications network 120 to business-unit computing system 162, e.g., at or about 8:30 a.m. and in advance of the 10:00 a.m. delivery deadline. Executed post-processing module 238 may perform operations that store transformed elements 240 of predicted output data within output data 142 of pipelining data store 134 (e.g., in conjunction with process identifier 204, and that generate one or more elements of a post-processing log 242 that characterize a successful completion of the post-processing operations and the successful provisioning of transformed elements 240, and that store the elements of the post-processing log 242 within log data 140 of pipelining data store 134. In other examples, executed post-processing module 238 may experience a failure in the application of the post-processing operations to the customer-specific elements of predicted output data 228, or may be incapable of provisioning of transformed elements 240 to business-unit computing system 162 (e.g., due to a connectivity error or a network failure, etc.). Based on the experienced failure in the post-processing operations or in the provisioning of transformed elements 240, executed post-processing module 238 may perform operations (not illustrated in FIG. 2B) that generate additional elements of post-processing log 242 that identify and characterize the failure in the post-processing operations or in the provisioning of transformed elements.

Through an implementation of the exemplary data-pipelining operations described herein, executed data pipelining engine 144 may facilitate an application of the trained, gradient-boosted, decision-tree process to each of customer-specific input datasets 220, a generation of customer-specific elements of predicted output data 228 associated with each of customer-specific input datasets 220, and further, a provisioning of transformed elements 240 of predicted output data to business-unit computing system 162 in accordance with the elements of scheduling data 208. In further examples, not illustrated in FIGS. 2A and 2B, process data 136 may maintain a process identifier associated with one or more additional, or alternatively, trained machine learning or artificial intelligence processes, and executed data pipelining engine 144 may perform any of the exemplary data pipelining operations described herein to facilitate, for each of the additional, or alternate, trained machine learning or artificial intelligence processes, an application of that trained machine learning or artificial intelligence process to corresponding customer-specific input datasets, a generation of customer-specific elements of predicted output data associated with each of customer-specific input datasets, and further, a provisioning of transformed elements of predicted output data to a corresponding one of business-unit systems 160 in accordance with the additional, or alternate, elements of scheduling data maintained within delivery data 138 of pipelining data store 134. Further, and through an implementation of any of the exemplary processes described herein, the one or more distributed components of FI computing system 130 may monitor a success, delay, or alternatively, a failure of each of the discrete, process-specific data pipelining operations, and to generate and maintain elements of log data (e.g., within portions of log data 140) that characterize an implementation of each of the process-specific data pipelining operations and identify a corresponding success, delay, or failure of corresponding one of the process-specific data pipelining operations.

As described herein, a successful, and timely, execution of these data pipelining processes may facilitate a timely an application of each of the trained machine learning or artificial intelligence process to the corresponding customer-specific input datasets, a generation of corresponding elements of predicted output data, and a transformation and provisioning of that predicted output to the corresponding ones of business-unit systems 160 in accordance with an underlying delivery schedule. In some examples, load balancing issues may delay an initiation of a data-pipelining operation associated with a corresponding one of the trained, machine learning or artificial intelligence processes by the distributed components of FI computing system 130, which may delay a delivery of the transformed elements of predicted output data to one or more of business-unit systems 160 beyond a corresponding delivery deadline. In other instances, a failure in an execution of the data-pipelining operation may prevent the one or more distributed components of FI computing system 130 from delivering the transformed elements of predicted output data to the corresponding one of business-unit systems 160 absent manual intervention, e.g., an initiation of one or more processes by analyst device 102 that triggering a re-ingestion of the source data elements by executed data-ingestion module 202.

By way of example, and for the trained, gradient-boosted decision-tree process described herein, the elements of scheduling data 208 may specify a daily delivery time of 11:00 a.m. for transformed elements 240 of predicted output data to business-unit computing system 162, and a daily initiation time of 3:30 a.m. for the data-pipelining operations that support the application of the trained, gradient-boosted decision-tree process to customer-specific input datasets 220. Barring any delays or failures in an execution of the data-pipelining operations by executed data pipelining engine 144, the one or more distributed components of FI computing system 130 may complete the data-pipelining operations and provision transformed elements 240 of predicted output data to business-unit computing system 162 by 8:30 a.m. on a daily basis, e.g., ninety minutes prior to the daily delivery time of 11:00 a.m. In some instances, the ninety-minute interval between the expected 8:30 a.m. delivery of the transformed elements 240 of predicted output data and the specified daily delivery time of 11:00 a.m. may nonetheless limit an ability of the one or more distributed components of FI computing system 130 to re-initiate a failed or delayed data-pipelining operation (e.g., based on programmatic instructions received from analyst device 102) with sufficient processing time to provision transformed elements 240 of predicted output data to business-unit computing system 162 prior to the specified daily delivery time of 11:00 a.m., absent a real-time detection of the failure or delay, and a real-time provisioning of a notification of the detected failure or delay to analyst device 102.

In some examples, the one or more distributed components of FI computing system 130 may perform operations that generate, and render for presentation at analyst device 102, a centralized digital interface (e.g., an interactive, digital dashboard) having interface elements that provide a graphical representation of a current status of each of the multiple, executed trained machine learning or artificial intelligence process and an aggregated rate of success or failure in the data-pipelining operations associated with each of the executed machine learning or artificial intelligence processes over one or more prior temporal intervals. Further, the interactive, digital dashboard may, upon presentation by analyst device 102, also include one or more interface elements that provide a graphical representation of a relative frequency of one or more data-pipelining or process-execution failures or delays across all executed machine learning or artificial intelligence processes during one or more temporal intervals, and further, that a graphical representation of an aggregate number of successful, or failed, process executions during a current and one or more prior temporal intervals.

The presentation of the aggregated and process-specific data within the dashboard by analyst device 102 may enable analyst 101 to not only identify and mediate, in real-time, the potential choke points in the data-pipelining operations associated with, and the execution of, one or more of the machine learning or artificial intelligence processes, but also enable a characterization and improvement (e.g., via load-balancing) of an efficiency of the data-pipelining operation performed by the one or more distributed components of FI computing system 130, and a determination of a predicted consumption of computational resources during an execution of data-pipelining operations that support an additional, or alternate, machine learning or artificial intelligence process. Certain of these exemplary processes, which provide a centralized and interactive digital interface characterizing a current status of each of the multiple, executed trained machine learning or artificial intelligence processes, and corresponding ones of the process-specific data pipelining operations, and which identifies, in real-time and on a time-evolving basis, delays or failures associated with one or more of the executed trained machine learning or artificial intelligence processes, or corresponding ones of the process-specific data pipelining operations, may be implemented in addition to, or as an alternate to, existing notification processes that generate and provision process- or operation-specific notifications of detected delays or failures to an analyst device for sequential presentation within one or more digital interfaces.

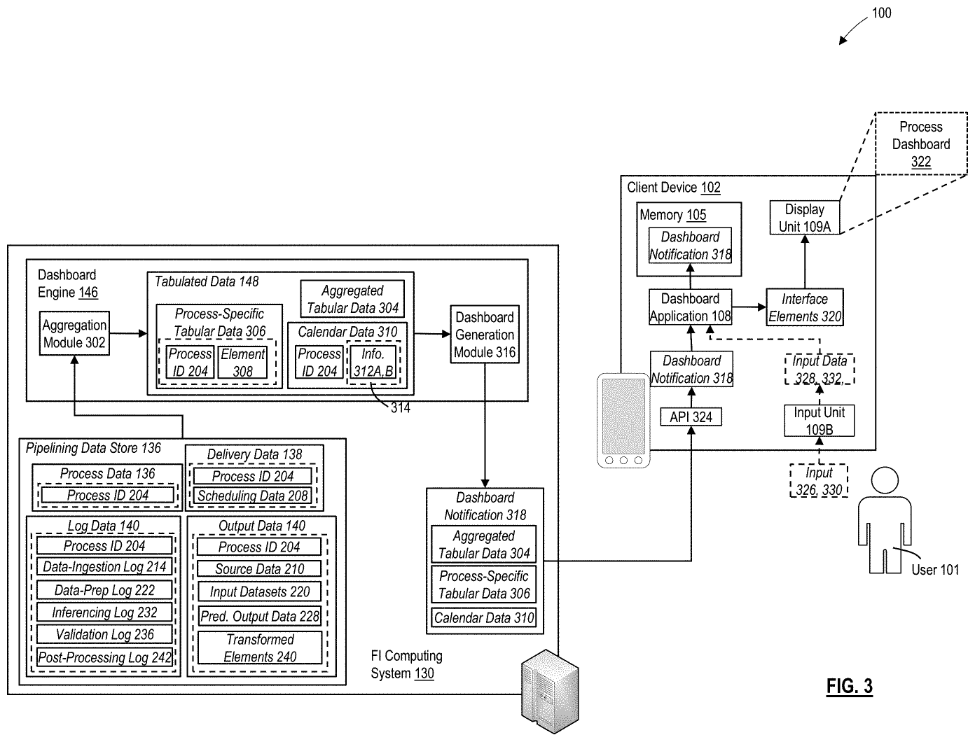

Referring to FIG. 3, and upon execution by the one or more processors of FI computing system 130, executed dashboard engine 146 may perform any of the exemplary processes described herein to parse elements of process data 136, delivery data 138, and log data 140 maintained within pipelining data store 134, and to generate values of one or more metrics that characterize a success, failure, or delay (e.g., based on a comparison of actual and expected times) in an execution of one or more of the data-pipelining operations described herein, on both an aggregate basis across the trained machine learning or artificial intelligence processes during one or more temporal intervals, and on a process-specific basis during the one or more temporal intervals. By way of example, an aggregation module 302 of executed dashboard engine 146 may access process data 136 of pipelining data store 134 and obtain a unique process identifier of each, or a selected subset, of the trained machine learning or artificial intelligence processes associated with the process-specific data-pipelining operations executed simultaneously, or contemporaneously, by the distributed components of FI computing system 130 (e.g., through an implementation of one or more of the exemplary, parallelized, fault-tolerant distributed computing and analytical processes described herein).

Further, executed aggregation module 302 may access delivery data 138 of pipelining data store 134, and obtain one or more elements of process-specific elements of scheduling data associated with corresponding ones of the obtained process identifiers. By way of example, and as described herein, the process-specific elements of scheduling data may specify, for each of the trained, machine learning or artificial intelligence process, a scheduled date or time associated with a delivery of transformed elements of predicted output data to a corresponding one of business-unit systems 160, a scheduled initiation date or time associated with the process-specific data-pipelining operations, and additionally, or alternatively, an expected end-to-end processing time for the process-specific data-pipelining operations. In some instances, the one or more elements of process-specific elements of scheduling data may also specify, for each of the trained, machine learning or artificial intelligence processes, an expected processing time associated with each, or a selected subset of, corresponding ones of the process-specific data-pipelining operations, such as, but not limited to, the exemplary data-ingestion, data-preparation, inferencing, validation, and post-processing operations described herein.

By way of example, executed aggregation module 302 may access process data 136, and obtain process identifier 204 associated with the trained, gradient-boosted, decision-tree process described herein (e.g., the predicted a likelihood of an occurrence of a target event involving a customer of the financial institution during a future temporal interval, etc.). In some instances, executed aggregation module 302 may access delivery data 138 of pipelining data store 134, and obtain one or more elements of scheduling data 208 associated with process identifier 204 and with the trained, gradient-boosted, decision-tree process. As described herein, the elements of scheduling data 208 may specify a daily delivery time of 11:00 a.m. for transformed elements 240 of predicted output data to business-unit computing system 162, and a daily initiation time of 3:30 a.m. for the data-pipelining operations that support the application of the trained, gradient-boosted decision-tree process to customer-specific input datasets 220. Further, the elements of scheduling data 208 may also specify the expected, end-to-end execution time of the data-pipelining operations associated with the trained, gradient-boosted, decision-tree process (e.g., five hours), and in some instances, expected execution for one or more of the discrete, data-pipelining operations associated with the trained, gradient-boosted, decision-tree process.

Further, and based on the obtained process identifiers, executed aggregation module 302 may also obtain one or more elements of log data 140, which identify and characterize, for each of the trained, machine learning or artificial intelligence processes, a performance and an outcome (e.g., success or failure) of corresponding ones of the data-pipelining operations that support the application of the trained, machine learning or artificial intelligence process to corresponding, customer-specific input datasets and the provisioning of transformed elements of predictive output to corresponding ones of business-unit systems 160. In some instances, and for each of the trained, machine learning or artificial intelligence processes (including the trained, gradient-boosted, decision-tree process described herein), executed aggregation module 302 may obtain from log data 140: (i) one or more elements of data-ingestion log that characterize a success, or failure, of the data-ingestion operations described herein for corresponding ones of the trained, machine learning or artificial intelligence processes; (ii) elements of a data-preparation log that characterize a success, or failure, of the data-preparation operations described herein for corresponding ones of the trained, machine learning or artificial intelligence processes; (iii) elements of a inferencing log that characterize the success, or the failure, of the application of corresponding ones of the trained, machine learning or artificial intelligence processes to input datasets; (iv) elements of a validation log that characterize the success or failure of the validation operations described herein for corresponding ones of the trained, machine learning or artificial intelligence processes; and (v) elements of a post-processing log that characterize a success, or failure, of the post-processing and data delivery operations described herein for corresponding ones of the trained, machine learning or artificial intelligence processes.

In some examples, the elements of the data-ingestion log, the data-preparation log, the inferencing log, the validation log, and post-processing log may characterize the execution, and corresponding success or failure, of these exemplary data-pipelining operations by executed data pipelining engine 144 during a current temporal interval (e.g., during a current month, etc.) or during one or more prior temporal intervals (e.g., one or more prior months, etc.), and executed aggregation module 302 may obtain the elements of scheduling data, and the elements of the data-ingestion log, the data-preparation log, the inferencing log, the validation log, and post-processing log, associated with each of the trained, machine learning or artificial intelligence processes at predetermined intervals, or in response to certain triggering events. Further, each of the elements of the data-ingestion log, the data-preparation log, the inferencing log, the validation log, and post-processing log may include data characterizing a success, or failure, of the corresponding data-pipelining operation (e.g., a data flag, etc.) and temporal data that includes a starting time stamp (e.g., T_{START}) and an ending time stamp (T_{END}) for the corresponding data-pipelining operation. Further, in some instances, if one of the data-pipelining operations (e.g., the exemplary data-ingestion operation described herein, etc.) were to experience a failure, the corresponding elements of the data-ingestion log, the data-preparation log, the inferencing log, the validation log, and post-processing log may include additional data indicative of a reason for the failure. By way of example, and for a failure of the data-ingestion operation associated with a corresponding one of the trained, machine learning or artificial intelligence processes during a temporal interval, the elements of the data-ingestion log associated with the corresponding one of the trained, machine learning or artificial intelligence processes and the temporal interval may include additional data indicative of either a programmatic initiation of the data-ingestion process or alternatively, or a manual initiation of the data-ingestion process (e.g., a re-ingestion initiated in response to a failure, etc.).

In some instances, executed aggregation module 302 may perform operations that, based on the elements of scheduling data, and the elements of the data-ingestion log, the data-preparation log, the inferencing log, the validation log, and post-processing log, associated with each of the trained, machine learning or artificial intelligence processes, generate values of one or more metrics that characterize a success, failure, or delay of one or more of the data-pipelining or process-operations described herein, on both an aggregate basis across all of the trained, machine learning or artificial intelligence processes during one or more temporal intervals, and on a process-specific basis during the one or more temporal intervals. As illustrated in FIG. 3, executed aggregation module 302 may package all, or a selected portion, of the generated aggregated metric values and the generated process-specific metric values into corresponding portions of tabulated data 148, which may be provisioned as input to a dashboard generation module 316 of executed dashboard engine 146.

For example, tabulated data 148 may include elements of aggregated tabular data 304 that identifies a total number of data-pipelining operations executed by the distributed components of FI computing system 130 (e.g., by executed data pipelining engine 144, etc.) during a current temporal interval, and during one or more prior temporal intervals (e.g., during each month of a prior calendar year). Further, in some examples, the elements of aggregated tabular data may also identify a portion of the total number of executed data-pipelining operations that represent successful executions and failed executions, respectively, during the current temporal interval and during the one or more prior temporal intervals (e.g., number of successful executions and a number of failed executions), and additionally, or alternatively, rates at which the executed data-pipelining succeed or fail during the current temporal interval and during the one or more prior temporal intervals (e.g., percentages of successful and failed executions, etc.).

By way of example, to generate the elements of aggregated tabular data 304, executed aggregation module 302 may perform operations that parse the obtained elements of the data-ingestion log, the data-preparation log, the inferencing log, the validation log, and post-processing log, associated with each of the trained, machine learning or artificial intelligence processes, determine, during the current temporal and each of the prior temporal intervals, the total number of executed data-pipelining operations and the numbers of executed data-pipelining operations resulted in success and failure, respectively. Further, based on the numbers of executed data-pipelining operations resulted in success and failure, and on the total number of executed data-pipelining operations, executed aggregation module 302 may determine a rate (e.g., a percentage) of the executed data-pipelining operations that resulted in success or failure across the current and prior temporal intervals, and during each of the current and prior temporal intervals. Executed aggregation module 302 may perform operations that package the total number of executed data-pipelining operations, the numbers of executed data-pipelining operations resulted in success and failure, and the rates of success and failure across the current and prior temporal intervals, and during each of the prior temporal intervals, within corresponding elements of aggregated tabular data 304.

Further, when associated with a failed execution of a corresponding data-pipelining operation, the obtained elements of the data-ingestion log, the data-preparation log, the inferencing log, the validation log, and post-processing log may also include information identifying a particular cause of the failure. In some examples, executed aggregation module 302 may parse the elements of the data-ingestion log, the data-preparation log, the inferencing log, the validation log, and post-processing log associated with the failed data-pipelining operations, and identify a plurality of causes for the corresponding failures. The identified causes may include, but are not limited, data-ingestions failure, data-preparation failures, ingestion failures, validation failure, post-processing failures, or other hardware, communication, or load-balancing failures, and based on the elements of the data-ingestion log, the data-preparation log, the inferencing log, the validation log, and post-processing log, executed aggregation module 302 may perform operations that identify a number of the failed data-pipelining operations attributable to each of the identified causes, and compute a percentage contribution of each of the identified causes to the number of failed data-pipelining operations. Executed aggregation module 302 may perform operations that package data identifying each of the failure causes into the elements of aggregated tabular data 304, along ith the number of failed data-pipelining operations attributable to corresponding ones of the identified causes and the corresponding percentage contribution.

Tabulated data 148 may also include one or more elements of process-specific tabular data 306. For example, each element of process-specific tabular data 306 may be associated with a corresponding one of the trained, machine learning or artificial intelligence processes, and may be associated with a corresponding process identifier, such as those described herein. Each of the elements of process-specific tabular data 306 may also include, for the corresponding one of the trained, machine learning or artificial intelligence processes, information characterizing a status of the associated data-pipelining operations and data characterizing a total success or failure rate across a current temporal interval and one or more prior temporal intervals (e.g., percentage of successful completions of, or failures within, the data-pipelining operations). Further, one or more of the elements of process-specific tabular data 306 may also include, for corresponding ones of the trained, machine learning or artificial intelligence processes, process-specific percentages of successful completions of, and failures within, the data-pipelining operations during multiple temporal intervals, and additionally, or alternatively, process-specific contributions (e.g., percentages) of each failure causes to the total number of process-specific failures detected within log data 140. Additionally, in some instances, one or more of the elements of process-specific tabular data 306 may also include, for the corresponding ones of the trained, machine learning or artificial intelligence processes, a total number of manual initiations of the data-ingestion operations described herein (e.g., a re-ingestion due to detected failure) during the current and prior temporal intervals.

By way of example, and for the trained, gradient-boosted, decision-tree process associated with process identifier 204, executed aggregation module 302 may obtain, from log data 140, elements of data-ingestion log 214, data-preparation log 222, inferencing log 232, validation log 236, and post-processing log 242. Executed aggregation module 302 may perform any of the exemplary processes described herein to, based on the elements of data-ingestion log 214, data-preparation log 222, inferencing log 232, validation log 236, and post-processing log 242, determine a total number of executed data-pipelining operations associated with the trained, gradient-boosted, decision-tree process, and the numbers of executed data-pipelining operations resulting in success and failure, respectively, during the current temporal and each of the prior temporal intervals. Further, based on the numbers of executed data-pipelining operations resulted in success and failure, and on the total number of executed data-pipelining operations, executed aggregation module 302 may determine a rate (e.g., a percentage) of the executed data-pipelining operations associated with the trained, gradient-boosted, decision-tree process that resulted in success or failure across the current and prior temporal intervals, and during each of the current and prior temporal intervals. Executed aggregation module 302 may perform operations that package the total number of executed data-pipelining operations, the numbers of executed data-pipelining operations resulted in success and failure, and the rates of success and failure across the current and prior temporal intervals, and during each of the prior temporal intervals, into portions of an element 308 of process-specific tabular data 306, and that associate element 308 with process identifier 204 of the trained, gradient-boosted, decision-tree process.

Executed aggregation module 302 may perform any of the exemplary processes described herein to, based on the elements of data-ingestion log 214, data-preparation log 222, inferencing log 232, validation log 236, and post-processing log 242 associated with failed data-pipelining operations, determine a number of the failed data-pipelining operations associated with the trained, gradient-boosted, decision-tree process that are attributable to each of the identified causes, and compute a percentage contribution of each of the identified causes to the number of failed data-pipelining operations. Executed aggregation module 302 may perform operations that package data identifying each of the failure causes into a corresponding portion of element 308, along with the number of failed data-pipelining operations attributable to corresponding ones of the identified causes and the corresponding percentage contribution for the trained, gradient-boosted, decision-tree process.

Further, tabulated data 148 may also include one or more elements of calendar data 310 that, during each of a plurality of temporal intervals (e.g., a month), identity a time and date of each scheduled execution of the data-pipelining operations associated with each of the trained, machine learning or artificial intelligence processes, and a scheduled delivery time or date associated with the transformed elements of predicted output generated through the execution of the data-pipelining operations. In some instances, executed aggregation module 302 may parse corresponding, process-specific scheduling data maintained within delivery data 138 to obtain elements of process-specific information that identifies each of the scheduled initiations of data-pipelining operations, and to package each of the elements of process-specific information and a corresponding process identifier into an element of calendar data 310. Additionally, or alternatively, executed aggregation module 302 may also parse the elements of the data-ingestion logs associated with corresponding ones of the trained, machine learning or artificial intelligence processes, identify a time stamp associated with each manual initiation of the data-pipelining operations associated with corresponding ones of the trained, machine learning or artificial intelligence processes into a corresponding element of calendar data 310.

By way of example, and for the trained, gradient-boosted, decision-tree process associated with process identifier 204, executed aggregation module 302 may obtain elements of scheduling data 208 from delivery data 138 maintained within pipelining data store 134, and based on the elements of scheduling data 208, executed aggregation module 302 may obtain information 312A that identifies the 11:00 a.m. daily delivery time for the delivery of transformed elements of predicted output data associated with the trained, gradient-boosted, decision-tree process, and the 3:30 a.m. daily initiation time for the data-pipelining operations that support the application of the trained, gradient-boosted decision-tree process to customer-specific input datasets. Further, and based on obtained elements of the data-ingestion log associated with the trained, gradient-boosted, decision-tree process (e.g., elements of data-ingestion log 214, as described herein), executed aggregation module 302 may determine that analyst device 102 generated programmatic instructions to re-initiate the data-ingestion operations associated with the trained, gradient-boosted decision-tree at 4:30 a.m. on Aug. 23, 2021, and may generate additional information 3126 that identifies the time and date of the re-initiated data-ingestion operations. In some instances, executed aggregation module 302 may package information 312A and 312B into corresponding portions of an element 314 of calendar data 310 along with process identifier 204.

Referring back to FIG. 3, executed aggregation module 302 may provide the elements of tabulated data 148, including the elements of aggregated tabular data 304, process-specific tabular data 306, and calendar data 310, as inputs to a dashboard generation module 316 of executed dashboard engine 146. In some instances, executed dashboard generation module 316 may process the elements of aggregated tabular data 304, process-specific tabular data 306, and calendar data 310, and generate status data 319 that includes all, or selected portions of the aggregated tabular data 304, process-specific tabular data 306, and calendar data 310. In some examples, as illustrated in FIG. 3, executed dashboard generation module 316 may package one or more of the elements of aggregated tabular data 304, process-specific tabular data 306, and calendar data 310 into corresponding portions of a dashboard notification 318. Executed dashboard generation module 316 may also perform operations that cause FI computing system 130 to transmit dashboard notification 318 across communications network 120 to analyst device 102.

A programmatic interface associated with one or more application programs executed at analyst device 102, such as application programming interface (API) 324 associated with dashboard application 108, may receive dashboard notification 318. Additionally, API 324 may perform operations that cause analyst device 102 to execute dashboard application 108 (e.g., through a generation of a programmatic command, etc.). Upon execution by the one or more processors of analyst device 102, executed dashboard application 108 may receive dashboard notification 318 from API 324, and executed dashboard application 108 may store dashboard notification 318 within a corresponding portion of memory 105. Executed dashboard application 108 may perform operations that obtain all, or a selected portion, of aggregated tabular data 304, process-specific tabular data 306, and calendar data 310 from dashboard notification 318, and that process the elements of aggregated tabular data 304, process-specific tabular data 306, and calendar data 310 and generate interface elements 320 associated with one or more display screens or windows of a digital interface, such as, but not limited to, an interactive process dashboard 322.

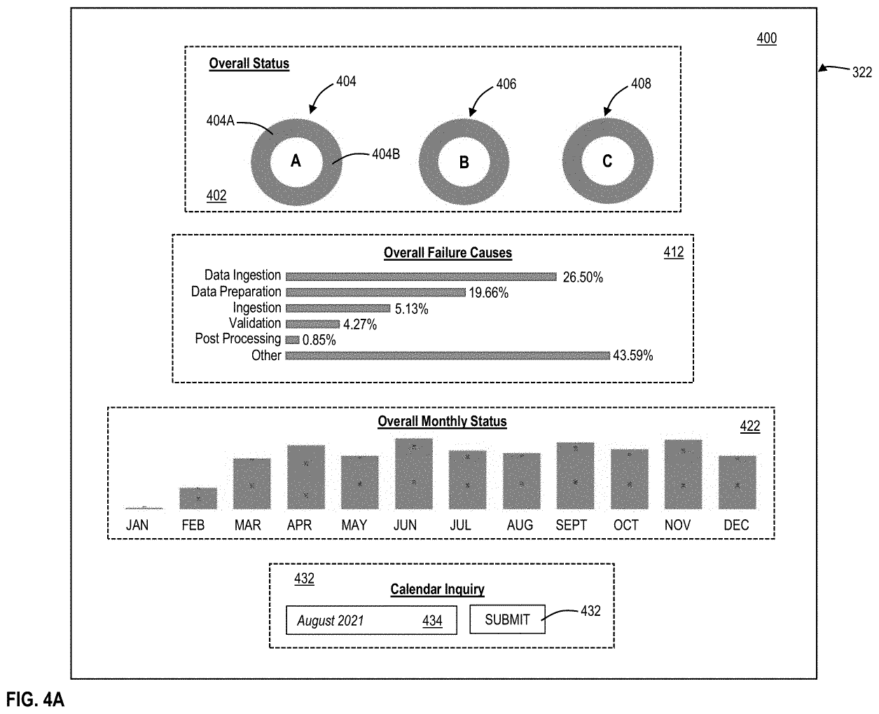

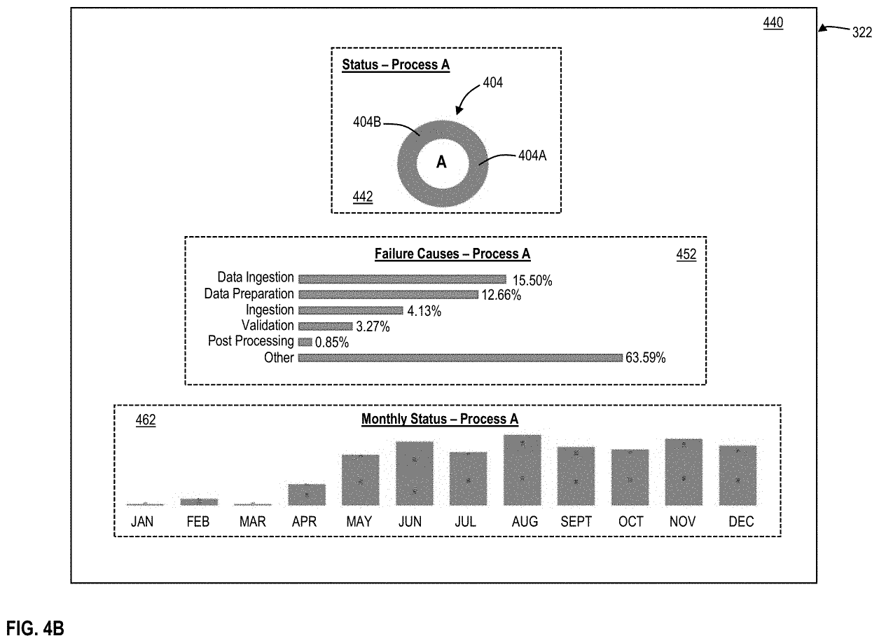

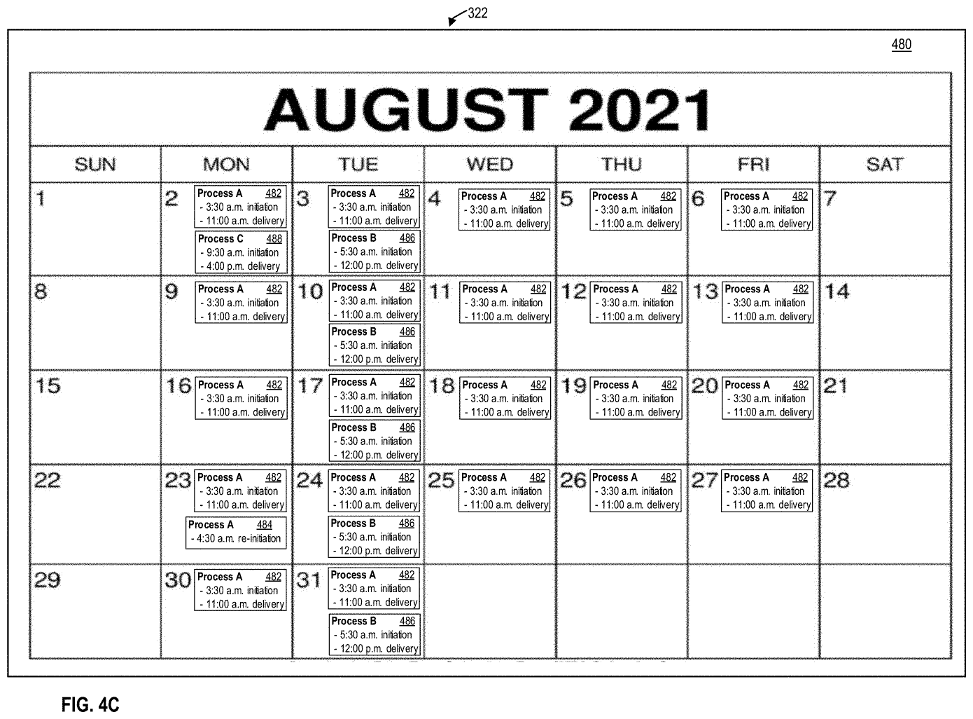

For example, when rendered for presentation within process dashboard 322 (e.g., by display unit 109A of analyst device 102), one or more of interface elements 320 may provide graphical representations that visualize a current status of the supporting data pipelining operations associated with one or more of the trained, machine learning or artificial intelligence processes, including the trained, gradient-boosted, decision-tree process described herein. Further, and as described herein, when rendered for presentation by display unit 109A of analyst device 102, process dashboard 322 may enable analyst device 102 to determine an impact of a particular delay or failure on the delivery schedule associated with the corresponding business unit, or on delivery schedules associated with other simultaneously or contemporaneously executed ones of the trained, machine learning or artificial intelligence processes. Additionally, executed dashboard application 108 may perform operations that route portions of interface elements 320 to display unit 109A, which may render the portions interface elements 320 for presentation within one or more display screens or windows of process dashboard 322, such as a global status screen 400 of FIG. 4A.

Referring to FIG. 4, global status screen 400 may include interface elements 402 that present a graphical representation of a total success or failure rate of the data-pipelining operations associated with all, or a selected subset, of the trained, machine learning or artificial intelligence processes over a current and one or more prior temporal intervals. For example, interface elements 402 may include discrete, process-specific interface elements 404, 406, and 408, each of which provide a graphical representation of the total success or failure rate of a respective one of the trained, machine learning or artificial intelligence processes (e.g., identified by process identifiers A, B, and C). Further, one or more of process-specific interface elements 404, 406, and 408 may correspond to a pie chart having a first portion representative of a failure rate associated with the corresponding one of the trained, machine learning or artificial intelligence process, and a second portion representative of a success rate associated with the corresponding one of the trained, machine learning or artificial intelligence process.

By way of example, and for the trained, gradient-boosted, decision-tree process described herein (e.g., represented by process identifier A), process-specific interface elements 404 may include a first portion 404A representative of a percentage failure rate of the data-pipelining operations associated with the trained, gradient-boosted, decision-tree process during the over a current temporal interval an in some instances, one or more prior temporal intervals, and a second portion 404B representative of a percentage success rate of the data-pipelining operations associated with the trained, gradient-boosted, decision-tree process during the over a current and/or prior temporal intervals. In some instances, differences between the visual characteristics of first portion 404A (e.g., a red color) and second portion 404B (e.g., a green color) may enable analyst 101 to the visually perceive the success and failure rates of the trained, gradient-boosted, decision-tree process, and may enhance an ability of analyst 101 to interact with process dashboard 200 using analyst devices characterized by limited display or input functionality.

Global status screen 400 may also include interface elements 412 that present a graphical representation of the determined contribution (e.g., a percentage) of each of the failure causes to the total number of failures detected in the data-pipelining operations associated with the trained, machine learning or artificial intelligence processes during the current and/or prior temporal intervals. For example, as illustrated in FIG. 4A, interface elements 412 indicate that: 26.5% of all detected failures result from a failed performance of the data-ingestion operations described herein (e.g., unavailable source data, failed data refresh, etc.); 19.66% of all detected failures result from a failed performance of the data-preparation operations described herein (e.g., missing or corrupted source data, failed database access or tokenization, etc.); 5.13% of all detected failures result from a failure during inferencing (e.g., due to a failure of an edge node, a communications or data-transmission error, etc.); 4.27% of all detected failures result from a failure in the validation operations described herein (e.g., inconsistencies between predictive output and prior inference data, inconsistencies between actual and expected data structure, etc.); and 0.85% of all detected failures result from a failure in the post-processing operations describe herein processing, such as a failure in the transformation of the predicted output or a failure in the provisioning of the transformed output to the business-unit systems 160. Further, interface elements 412 also indicate that 43.59% of all detected failures result from other, unrelated errors, such as, but not limited to, hardware, software, connectivity, or load-balancing issues.

As illustrated in FIG. 4A, global status screen 400 may also include interface elements 422 that characterize an aggregate, total success or failure rate across each of the trained, machine learning or artificial intelligence processes over one or more current and prior temporal intervals, e.g., on a monthly basis over a past calendar year. For example, one or more of interface elements 422 may a bar diagram having a first portion representative of the total failure rate (e.g., a failure percentage) across the trained, machine learning or artificial intelligence processes during respective months of the past calendar year, and a second portion representative of the total success rate across the trained, machine learning or artificial intelligence processes during respective months of the past calendar year. In some instances, differences between the visual characteristics of the first portion (e.g., a red color) and the second portion (e.g., a green color) may enable analyst 101 to the visually perceive the total success and failure rates, and as described herein, may enhance an ability of analyst 101 to interact with process dashboard 200 using analyst devices characterized by limited display or input functionality.

Additionally, analyst device 102 may perform additional operations that generate, and render for presentation, one more additional or alternate process-specific screens or windows of process dashboard 322 that are associated with, and characterize, discrete ones of the trained, machine learning or artificial intelligence processes. For example, referring to FIG. 3, analyst 101 may provide input 326 to analyst device 102 (e.g., via a corresponding input unit 109B) that selects process-specific interface element 404 associated with the trained, gradient-boosted, decision-tree process described herein, and input unit 109B may route input data 328 to executed dashboard application 108, and responsive to the selection of process-specific interface element 404, executed dashboard application 108 may perform operations that route an additional portion of interface elements 320 to display unit 109A, which may render the additional portion of interface elements 320 for presentation within a process-specific status screen of process dashboard 322 associated with the trained, gradient-boosted, decision-tree process, such as a process-specific status screen 440 of FIG. 4B. In some instances, process-specific status screen 440 may replace global status screen 400 within process dashboard 322, or alternatively, may obscure a portion of the interface elements within global status screen 400 (e.g., as a pop-up, etc.).

Referring to FIG. 4B, process-specific status screen 440 include interface elements 442 that present a graphical representation of a total success or failure rate of the data-pipelining operations associated with the trained, gradient-boosted, decision-tree process. For example, interface elements 442 may include process-specific interface elements 404, which includes first portion 404A representative of a percentage failure rate of the data-pipelining operations associated with the trained, gradient-boosted, decision-tree process during the over a current temporal interval an in some instances, one or more prior temporal intervals, and second portion 404B representative of a percentage success rate of the data-pipelining operations associated with the trained, gradient-boosted, decision-tree process during the over a current and/or prior temporal intervals. As described herein, the differences between the visual characteristics of first portion 404A (e.g., a red color) and second portion 404B (e.g., a green color) may enable analyst 101 to the visually perceive the success and failure rates of the trained, gradient-boosted, decision-tree process, and may enhance an ability of analyst 101 to interact with process dashboard 200 using analyst devices characterized by limited display or input functionality.

Process-specific status screen 440 may also include interface elements 452 that present a graphical representation of the determined contribution (e.g., a percentage) of each of the failure causes to the total number of failures detected in the data-pipelining operations associated with the trained, gradient-boosted, decision-tree process during the current and/or prior temporal intervals. For example, as illustrated in FIG. 4B, interface elements 412 indicate that: 15.5% of all detected failures result from a failed performance of the data-ingestion operations described herein (e.g., unavailable source data, failed data refresh, etc.); 12.66% of all detected failures result from a failed performance of the data-preparation operations described herein (e.g., missing or corrupted source data, failed database access or tokenization, etc.); 4.13% of all detected failures result from a failure during inferencing (e.g., due to a failure of an edge node, a communications or data-transmission error, etc.); 3.27% of all detected failures result from a failure in the validation operations described herein (e.g., inconsistencies between predictive output and prior inference data, inconsistencies between actual and expected data structure, etc.); and 0.85% of all detected failures result from a failure in the post-processing operations describe herein processing, such as a failure in the transformation of the predicted output or a failure in the provisioning of the transformed output to the business-unit systems 160. Further, interface elements 452 also indicate that 63.59% of all detected failures result from other, unrelated errors, such as, but not limited to, hardware, software, connectivity, or load-balancing issues.

As illustrated in FIG. 4B, process-specific status screen 440 may also include interface elements 452 that characterize an aggregated, total success or failure rate across each of the trained, gradient-boosted, decision-tree process processes over one or more of the current and prior temporal intervals, e.g., on a monthly basis over a past calendar year. For example, one or more of interface elements 452 may include a bar diagram having a first portion representative of the total failure rate (e.g., a failure percentage) across the trained, machine learning or artificial intelligence processes during respective months of the past calendar year, and a second portion representative of the total success rate across the trained, machine learning or artificial intelligence processes during respective months of the past calendar year. As described herein, the differences between the visual characteristics of the first portion (e.g., a red color) and the second portion (e.g., a green color) may enable analyst 101 to the visually perceive the total success and failure rates, and as described herein, may enhance an ability of analyst 101 to interact with process dashboard 200 using analyst devices characterized by limited display or input functionality.

Further, and referring back to FIG. 4A, global status screen 400 may also include one or more additional interface elements 432 that, based on additional input provisioned to analyst device 102, cause executed dashboard application 108 to generate an additional display screen or window of process dashboard 322 identifying a scheduled initiation date or time of data-pipelining operations associated with one or more of the trained, machine learning or artificial intelligence processes, and additionally, or alternatively, a scheduled delivery data or time for transformed elements of predicted output generated through an execution of the initiated data-pipelining operations (e.g., by executed data pipelining engine 144) during an analyst-specific temporal interval. For example, interface elements 432 may include an interactive interface element 434, such as a pull-down menu or a text box that, based on input provisioned to analyst device 102 (e.g., via input unit 109B), enable analyst 101 to specify a corresponding temporal interval (e.g., a prior month, etc.) and a “SUBMIT” icon 436 that upon selection by analyst 101, request that executed dashboard application 108 present and additional display screen or window of process dashboard 322 that identifies scheduling data characterizing the data-pipeline operations associated with one or more of the trained, trained, machine learning or artificial intelligence processes (e.g., scheduling screen 480 of FIG. 4C).

Referring to FIG. 3, analyst 101 may provide additional input 330 to analyst device 102 (e.g., via a corresponding input unit 109B) that specifies, via interaction interface element 414, a temporal interval corresponding to August 2021, and that selected SUBMIT icon 436, and input unit 109B may route additional input data 334 to executed dashboard application 108. Responsive to the specification of the temporal interval corresponding to August 2021, executed dashboard application 108 may perform operations that route an additional portion of interface elements 320 to display unit 109A, which may render the additional portion of interface elements 320 for presentation within a scheduling screen of process dashboard 322 associated with the analyst-specified temporal interval of August 2021, such as scheduling screen 480 of FIG. 4C. In some instances, scheduling screen 480 may replace global status screen 400 within process dashboard 322, or alternatively, may obscure a portion of the interface elements within global status screen 400 (e.g., as a pop-up, etc.).

Referring to FIG. 4C, scheduling screen 480 may include a plurality of process-specific icons representative of a scheduled initiation and/or delivery time associated with one or more of the trained, machine learning or artificial intelligence processes on corresponding days of the analyst-specific temporal interval, e.g., corresponding weekdays in August 2021. By way of example, and as described herein, the trained, gradient-boosted decision-tree process (e.g., associated with process A of FIGS. 4A and 4B) may be associated with a daily delivery time of 11:00 a.m. (e.g., for provisioning transformed elements 240 of predicted output data to business-unit computing system 162) and a corresponding dialing initiation time of 3:30 a.m. (e.g., for associating the corresponding data-pipelining operations). As illustrated in FIG. 4C, scheduling screen 480 may dispose a process-specific icon 482 associated with 3:30 a.m. initiation time and 11:00 a.m. delivery time for the trained, gradient-boosted decision-tree process within each weekday of August 2021. Further, and as described herein, the distributed components of FI computing system 130 may re-initiate the data-ingestion operations associated with the trained, gradient-boosted decision-tree at 4:30 a.m. on Aug. 23, 2021 (e.g., based on programmatic instructions generated by analyst device 102, etc.), and scheduling screen 480 may include an additional, process-specific icon 484 associated with 4:30 a.m. re-initiation of the data-ingestion operations on August 23, 2021.

Further, an additional one of the trained, machine learning or artificial intelligence processes (e.g., a trained, machine learning or artificial intelligence process associated with process B of FIG. 4A) may be associated with a delivery time of 12:00 p.m. on each Tuesday (e.g., for provisioning transformed elements of predicted output data to a corresponding one of business-unit systems 160) and a corresponding initiation time of 5:30 a.m. (e.g., for associating the corresponding data-pipelining operations). As illustrated in FIG. 4C, scheduling screen 480 may dispose a process-specific icon 486 associated with 5:30 a.m. initiation time and 12:00 p.m. delivery time for the trained, machine learning or artificial intelligence process associated with process B within each Tuesday of August 2021. In some examples, a further one of the trained, machine learning or artificial intelligence processes (e.g., a trained, machine learning or artificial intelligence process associated with process C of FIG. 4A) may be associated with a delivery time of 4:00 p.m. on the first weekday of each month (e.g., for provisioning transformed elements of predicted output data to a corresponding one of business-unit systems 160) and a corresponding initiation time of 9:30 a.m. (e.g., for associating the corresponding data-pipelining operations). As illustrated in FIG. 4C, scheduling screen 480 may dispose a process-specific icon 488 associated with 9:30 a.m. initiation time and 4:00 p.m. delivery time for the trained, machine learning or artificial intelligence process associated with process C within Aug. 2, 2021.

Through certain of these exemplary processes, process dashboard 322 may enable the analyst to visualize a current status of the simultaneously, and contemporaneously, data-processing operations associated with the trained, machine learning or artificial intelligence processes, and determine an impact of a particular delay or failure of these data-pipelining operations (e.g., associated with corresponding ones of the trained, machine learning or artificial intelligence process and corresponding ones of the business units) on a delivery schedule associated with the corresponding business unit, or on delivery schedules associated with other simultaneously or contemporaneously executed machine learning or artificial intelligence processes. Further, and through these exemplary processes, the one or more display screens or windows of process dashboard 322 may facilitate a real-time debugging of a data pipelining or execution of one or more of the trained, machine learning or artificial intelligence processes, and/or a real-time comparison of an actual data-pipelining or execution times for one or more of the trained, machine learning or artificial intelligence processes against corresponding “expected” times.

Further, through any of these exemplary processes described herein, FI computing system 130 may perform operations that identify and mediate the potential choke points in the data pipelining associated with, and the execution of, one or more of the trained, machine learning or artificial intelligence processes, but also enable a characterization and improvement (e.g., via load-balancing) of an efficiency of the data-pipelining processes described herein, and a determination of a predicted consumption of computational resources during data pipelining associated with, and an execution of, a new Machine learning or artificial intelligence process. Certain of these exemplary processes described herein may be implemented in addition to, or as an alternate to, one or more processes that generate and transmit sequential notifications (e.g., email messages, text messages, etc.) indicative of a detected delay or failure in the data pipelining processes associated with one or more trained, machine learning or artificial intelligence processes to a predetermined set of recipient devices or systems.

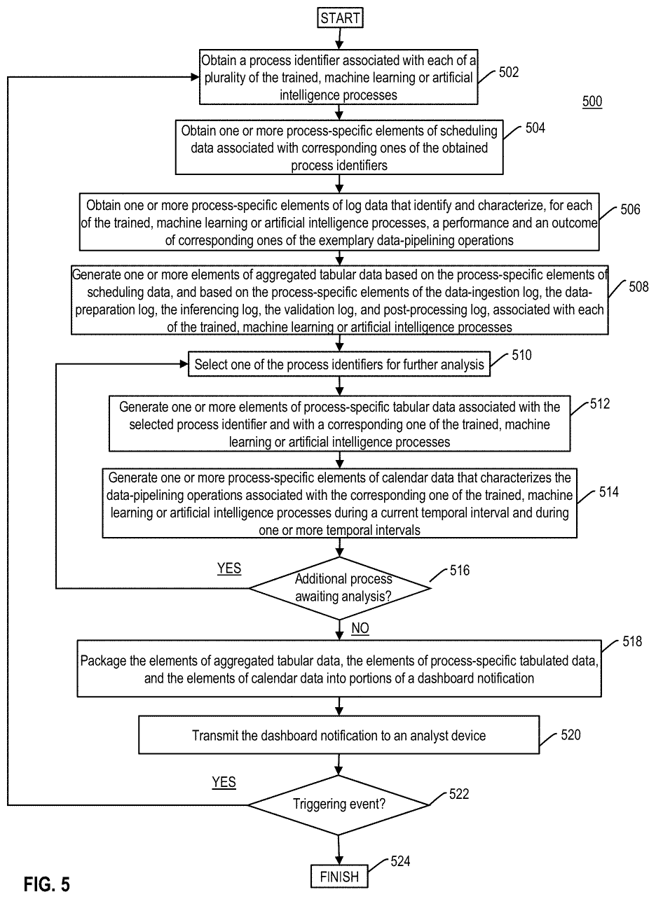

FIG. 5 is a flowchart of an exemplary process 500 for generating and maintaining an interactive, digital dashboard for trained, machine learning and artificial intelligence processes. In some examples, one or more computing systems associated with a financial institution, such as one or more of the distributed components of FI computing system 130, may perform one or more of steps of exemplary process 500, as described herein. Referring to FIG. 5, the one or more distributed computing components of FI computing system 130 may perform any of the exemplary processes described herein to obtain a process identifier associated with each of a plurality of the trained, machine learning or artificial intelligence processes (e.g., in step 502 of FIG. 5). As described herein, each of the plurality of trained, machine learning or artificial intelligence processes may be associated with the one or more of the process-specific data-pipelining operations executed simultaneously, or contemporaneously, by the distributed components of FI computing system 130 (e.g., through an implementation of one or more of the exemplary, parallelized, fault-tolerant distributed computing and analytical processes described herein), and the obtained process identifiers may be maintained within corresponding portions of process data 136 of pipelining data store 134.

In some instances, the one or more distributed components of FI computing system 130 may perform any of the exemplary processes described herein to obtain one or more elements of process-specific elements of scheduling data associated with corresponding ones of the obtained process identifiers (e.g., in step 504 of FIG. 5). By way of example, and as described herein, the process-specific elements of scheduling data may be maintained within corresponding portions of delivery data 138 of pipelining data store 134, and the process-specific elements of scheduling data may specify, for each of the trained, machine learning or artificial intelligence process, a scheduled date or time associated with a delivery of transformed elements of predicted output data to a corresponding one of business-unit systems 160, a scheduled initiation date or time associated with the process-specific data-pipelining operations, and additionally, or alternatively, an expected end-to-end processing time for the process-specific data-pipelining operations. In some instances, the process-specific elements of scheduling data may also specify, for each of the trained, machine learning or artificial intelligence processes, an expected processing time associated with each, or a selected subset of, corresponding ones of the process-specific data-pipelining operations, such as, but not limited to, the exemplary data-ingestion, data-preparation, inferencing, validation, and post-processing operations described herein.

Further, and based on the obtained process identifiers, the one or more distributed components of FI computing system 130 may also perform operations that obtain one or more process-specific elements of log data that identify and characterize, for each of the trained, machine learning or artificial intelligence processes, a performance and an outcome (e.g., success or failure) of corresponding ones of the exemplary data-pipelining operations, as described herein (e.g., in step 506 of FIG. 5). By way of example, the process-specific elements of log data may be maintained within corresponding portions of log data 140 of pipelining data store 134, and for each of the trained, machine learning or artificial intelligence processes, the one or more distributed components of FI computing system 130 may obtain from log data 140: (i) one or more elements of data-ingestion log that characterize a success, or failure, of the data-ingestion operations described herein for corresponding ones of the trained, machine learning or artificial intelligence processes; (ii) elements of a data-preparation log that characterize a success, or failure, of the data-preparation operations described herein for corresponding ones of the trained, machine learning or artificial intelligence processes; (iii) elements of a inferencing log that characterize the success, or the failure, of the application of corresponding ones of the trained, machine learning or artificial intelligence processes to input datasets; (iv) elements of a validation log that characterize the success or failure of the validation operations described herein for corresponding ones of the trained, machine learning or artificial intelligence processes; and (v) elements of a post-processing log that characterize a success, or failure, of the post-processing and data delivery operations described herein for corresponding ones of the trained, machine learning or artificial intelligence processes.

In some instances, the process-specific elements of the data-ingestion log, the data-preparation log, the inferencing log, the validation log, and the post-processing log may characterize the execution, and a success or failure, of corresponding ones of the exemplary data-pipelining operations during a current temporal interval (e.g., during a current month, etc.) or during one or more prior temporal intervals (e.g., one or more prior months, etc.). Further, each of the process-specific elements of the data-ingestion log, the data-preparation log, the inferencing log, the validation log, and post-processing log may include information characterizing a success, or failure, of the corresponding data-pipelining operation (e.g., a data flag, etc.) and temporal data that includes a starting time stamp and an ending time stamp for the corresponding data-pipelining operation. Further, in some instances, if one of the data-pipelining operations were to experience a failure, the corresponding, process-specific elements of the data-ingestion log, the data-preparation log, the inferencing log, the validation log, and post-processing log may include additional data indicative of a reason for the failure, such as the exemplary reasons described herein.

The one or more distributed components of FI computing system 130 may also perform any of the exemplary processes described herein to generate one or more elements of aggregated tabular data based on the process-specific elements of scheduling data, and based on the process-specific elements of the data-ingestion log, the data-preparation log, the inferencing log, the validation log, and post-processing log, associated with each of the trained, machine learning or artificial intelligence processes (e.g., in step 508 of FIG. 5). By way of example, the elements of aggregated tabular data may include, among other things, a total number of data-pipelining operations executed by the distributed components of FI computing system 130 (e.g., by executed data pipelining engine 144, etc.) during a current temporal interval, and during one or more prior temporal intervals (e.g., during each month of a prior calendar year. In some instances, the elements of aggregated tabular data may also identify a portion of the total number of executed data-pipelining operations that represent successful executions and failed executions, respectively, during the current temporal interval and during the one or more prior temporal intervals (e.g., number of successful executions and a number of failed executions), and additionally, or alternatively, rates at which the executed data-pipelining succeed or fail during the current temporal interval and during the one or more prior temporal intervals (e.g., percentages of successful and failed executions, etc.). Further, and as described herein, the elements of aggregated tabular data may also identify each of a plurality of causes for failures of the executed data-pipelining operations, and for each of the causes, a number of failed data-pipelining operations attributable to corresponding ones of the identified causes and a corresponding percentage contribution.

In some instances, in step 510 of FIG. 5, the one or more distributed components of FI computing system 130 may select one of the process identifiers (e.g., associated with a corresponding one of the trained, machine learning or artificial intelligence processes) for further analysis. The one or more distributed components of FI computing system 130 may also perform any of the exemplary processes described herein to generate one or more elements of process-specific tabular data associated with the selected process identifier and with a corresponding one of the trained, machine learning or artificial intelligence processes (e.g., in step 512 of FIG. 5). The elements of process-specific tabular data 306 may include, for the corresponding one of the trained machine learning or artificial intelligence processes, information characterizing a status of the associated data-pipelining operations and data characterizing a total success or failure rate across a current temporal interval and one or more prior temporal intervals (e.g., percentage of successful completions of, or failures within, the data-pipelining operations). One or more of the elements of process-specific tabular data may also include, for corresponding one of the trained, machine learning or artificial intelligence processes, process-specific percentages of successful completions of, and failures within, the data-pipelining operations during multiple temporal intervals, and additionally, or alternatively, process-specific contributions (e.g., percentages) of each failure cause to the total number of process-specific failures. Additionally, in some instances, one or more of the elements of process-specific tabular data 306 may also include, for the corresponding ones of the trained, machine learning or artificial intelligence processes, a total number of manual initiations of the data-ingestion operations described herein (e.g., a re-ingestion due to detected failure) during the current and prior temporal intervals.

Further, the one or more distributed components of FI computing system 130 may also perform any of the exemplary processes described herein to generate one or more process-specific elements of calendar data that characterizes the data-pipelining operations associated with the corresponding one of the trained, machine learning or artificial intelligence processes during a current temporal interval and during one or more temporal intervals (e.g., in step 514 of FIG. 5). For example, elements of calendar data may include, during the current and prior temporal intervals, a time and date of each scheduled execution of the data-pipelining operations associated with the corresponding one of the trained, machine learning or artificial intelligence processes, a scheduled delivery time or date associated with the transformed elements of predicted output generated through the execution of the process-specific data-pipelining operations, and in some instances, temporal data characterizing occurrences of manual re-initiations initiation of the data-pipelining operations associated with the corresponding one of the trained, machine learning or artificial intelligence processes.

In some instances, the one or more distributed components of FI computing system 130 may access the elements of process data 136 maintained within pipelining data store 134, and determine whether additional process identifiers await analysis and a computation of corresponding elements of process-specific tabular data and calendar data (e.g., in step 516 of FIG. 5). If, for example, the one or more distributed components of FI computing system 130 were to determine that additional process identifiers await analysis (e.g., step 516; YES), exemplary process 500 may pass back to step 510, and the one or more distributed components of FI computing system 130 may select an additional one of the process identifiers (e.g., associated with an additional one of the trained, machine learning or artificial intelligence processes) for further analysis.

Alternatively, if the one or more distributed components of FI computing system 130 were to determine that no additional process identifiers await analysis (e.g., step 516; NO), the one or more distributed components of FI computing system 130 may perform any of the exemplary processes described herein to package the elements of aggregated tabular data, the elements of process-specific tabulated data, and the elements of calendar data into corresponding portions of a dashboard notification (e.g., in step 518 of FIG. 5). The one or more distributed components of FI computing system 130 may perform operations, described herein, to transmit the dashboard notification across communications network 120 to analyst device 102 (e.g., in step 520 of FIG. 5). As described herein, analyst device 102 may receive the dashboard notification, which includes the elements of aggregated tabular data, the elements of process-specific tabulated data, and the elements of calendar data, and an application program executed by the one or more processors of analyst device 102, such as dashboard application 108, may process the elements of aggregated tabular data, the elements of process-specific tabulated data, and the elements of calendar data, generate corresponding interface elements, and render the interface elements for presentation within an interactive, digital dashboard, such as, but not limited to, process dashboard 322 of FIG. 3.

In some instances, one or more distributed components of FI computing system 130 may detect an occurrence of an event (e.g., a triggering event) associated with the interactive, digital dashboard, and determine whether the detected event triggers a performance of further operations to generate and transmit an updated dashboard notification to analyst device 102 (e.g., in step 522 of FIG. 5). By way of example, distributed components of FI computing system 130 may perform operations that generate and transmit updated dashboard notification to analyst device 102, and as such, that update or refresh the interactive, digital dashboard, in accordance with a predetermined schedule, and the detected triggering event may correspond to an expiration of a temporal interval specified by the predetermined schedule. In other examples, the distributed components of FI computing system 130 may perform operations that generate and transmit updated dashboard notification to analyst device 102, that update or refresh that interactive, digital dashboard, in response to a detected change in a composition of pipelining data store 134 (e.g., the maintenance of an additional process identifier within process data 136, or the maintenance of additional process-specific elements of log data 140, etc.), or in response to a request generated and transmitted by analyst device 102.

If, for example, the one or more distributed components of FI computing system 130 were to detect an occurrence of a triggering event (e.g., step 522; YES), exemplary process 500 may pass back to step 502, and the one or more distributed computing components of FI computing system 130 may perform any of the exemplary processes described herein to obtain a process identifier associated with each of a plurality of the trained, machine learning or artificial intelligence processes. Alternatively, if the one or more distributed components of FI computing system 130 were to fail to detect an occurrence of any triggering events (e.g., step 522; NO), exemplary process 500 may be complete in step 524.

### C. Exemplary Hardware and Software Implementations

Embodiments of the subject matter and the functional operations described in this disclosure can be implemented in digital electronic circuitry, in tangibly-embodied computer software or firmware, in computer hardware, including the structures disclosed in this specification and their structural equivalents, or in combinations of one or more of them. Embodiments of the subject matter described in this disclosure, including dashboard application 108, data pipelining engine 144, dashboard engine 146, application programming interfaces (APIs) 212 and 324, data-ingestion module 202, data-preparation module 216, inferencing module 221, validation module 234, post-processing module 238, aggregation module 302, and dashboard generation module 316, can be implemented as one or more computer programs, i.e., one or more modules of computer program instructions encoded on a tangible non-transitory program carrier for execution by, or to control the operation of, a data processing apparatus (or a computing system). Additionally, or alternatively, the program instructions can be encoded on an artificially-generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them

The terms “apparatus,” “device,” and “system” refer to data processing hardware and encompass all kinds of apparatus, devices, and machines for processing data, including by way of example a programmable processor, a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) or an assisted Global Positioning System (AGPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, such as user of analyst device 102, embodiments of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a client computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the disclosure or of what may be claimed, but rather as descriptions of features specific to particular embodiments of the disclosure. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, unless otherwise specifically defined herein, all terms are to be given their broadest possible interpretation including meanings implied from the specification as well as meanings understood by those skilled in the art and/or as defined in dictionaries, treatises, etc. It is also noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship. In this disclosure, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only and are not to be construed as limiting the described subject matter.

The foregoing is provided for purposes of illustrating, explaining, and describing embodiments of this disclosure. Modifications and adaptations to the embodiments will be apparent to those skilled in the art and may be made without departing from the scope or spirit of the disclosure.

What is claimed is:

1. An apparatus, comprising:
a communications interface;
a memory storing instructions; and
at least one processor coupled to the communications interface and to the memory, the at least one processor being configured to execute the instructions to:
obtain process data associated with an execution of a plurality of machine learning or artificial intelligence processes;
based on the process data, determine, for each of the plurality of machine learning or artificial intelligence processes, value of one or more metrics characterizing a status of one or more operations that support the execution of the corresponding machine learning or artificial intelligence process; and
generate status data for each of the machine learning or artificial intelligence processes, and transmit one or more elements of the status data to a device via the communications interface, the status data comprising, for each of the machine learning or artificial intelligence processes, the determined one or more metric values and a corresponding process identifier, and the status data causing the device to present, for each of the machine learning or artificial intelligence processes, a graphical representation of at least one of the determined one or more metric values within a digital interface.

2. The apparatus of claim 1, wherein the process data for each of the machine learning or artificial intelligence process comprises a plurality of elements, each of the process data elements being associated with a corresponding one of the operations, and each of the process data elements being indicative of a success or failure of an execution of the corresponding one of the operations.

3. The apparatus of claim 2, wherein:
the at least one processor is further configured to execute the instructions to:
determine, based on the process data elements associated with each of the machine learning or artificial intelligence processes, a first aggregate value characterizing a number of failed executions of the operations during one or more temporal intervals and a second aggregate value characterizing a number of successful executions of the operations during the one or more temporal intervals; and
compute at least one of an aggregate failure rate or an aggregate success rate based on the first and second aggregate values; and
the status data comprises the first aggregate value, the second aggregate value, and the at least one of the aggregate failure rate or the aggregate success rate.

4. The apparatus of claim 3, wherein the at least one process is further configured to execute the instructions to determine the first aggregate value and the second aggregate value during each of the one or more temporal intervals.

5. The apparatus of claim 2, wherein the at least one processor is further configured to execute the instructions to:
based on the process data elements, determine a first value characterizing a number of failed executions of the operations associated with each of the machine learning or artificial intelligence processes during one or more temporal intervals, and determine a second value characterizing a number of successful executions of the operations associated with each of the machine learning or artificial intelligence processes during the one or more temporal intervals;
compute a rate of successful or failed execution of the operations associated with each of the machine learning or artificial intelligence processes based on corresponding ones of the first and second values; and
generate, for each of the machine learning or artificial intelligence processes, an element of the status data that includes the corresponding process identifier, the corresponding ones of the first and second values, and corresponding ones of the success and failure rates.

6. The apparatus of claim 5, wherein the at least one process is further configured to execute the instructions to determine, each of the machine learning or artificial intelligence processes, the corresponding ones of the first and second values during each of the one or more temporal intervals.

7. The apparatus of claim 1, wherein the at least one processor is further configured to execute the instructions to:
obtain scheduling data associated with a corresponding one of the machine learning or artificial intelligence processes, the scheduling data comprising first temporal data and second temporal data, the first temporal data characterizing a scheduled initiation of a first one of the operations associated with the corresponding machine learning or artificial intelligence processes, and the second temporal data characterizing a scheduled provisioning of predicted output associated with the corresponding machine learning or artificial intelligence processes to a computing system; and
generate an element of the status data that includes the corresponding process identifier, the first temporal data, and the second temporal data.

8. The apparatus of claim 7, wherein the at least one processor is further configured to execute the instructions to:
obtain third temporal data associated with the corresponding machine learning or artificial intelligence process, the third temporal data characterizing a re-initiation of the first one of the operations based on a prior failure in an execution of the first one of the operations; and
generate an element of the status data that includes the corresponding process identifier and the third temporal data.

9. The apparatus of claim 1, wherein the plurality of machine learning or artificial intelligence processes comprises a trained, gradient-boosted, decision-tree process.

10. The apparatus of claim 1, wherein the at least one processor is further configured to execute the instructions to:
obtain a process identifier associated with at least one of the machine learning or artificial intelligence processes, and based on the process identifier, obtain elements of scheduling data and process input data associated with the at least one machine learning or artificial intelligence process;
perform operations that execute the one or more operations associated with the at least one machine learning or artificial intelligence process based on the process input data and the scheduling data; and
generate, for the at least one machine learning or artificial intelligence process, an element of the process data associated with each of the executed operations, the elements of the process data characterizing a success or a failure of corresponding ones of the executed operations.

11. The apparatus of claim 1, wherein the status data further causes the device to:
generate and present, and for each of the machine learning or artificial intelligence processes, a first graphical representation of a first subset of the one or more metric values within a portion of a digital interface;
receive input data indicative of a selection of one or the first graphical representation associated with a corresponding one of the machine learning or artificial intelligence processes; and
based on the input data, generate and present a second graphical representation of a second subset of the one or more metric values associated with the corresponding machine learning or artificial intelligence process within an additional portion of the digital interface.

12. A computer-implemented method, comprising:
obtaining, using at least one processor, process data associated with an execution of a plurality of machine learning or artificial intelligence processes;
based on the process data, determining, using the at least one processor, and for each of the machine learning or artificial intelligence processes, a value of one or more metrics characterizing a status of one or more operations that support the execution of the corresponding machine learning or artificial intelligence process; and
using the at least one processor, generating status data for each of the plurality of machine learning or artificial intelligence processes, and transmitting one or more elements of the status data to a device, the status data comprising, for each of the machine learning or artificial intelligence processes, the determined one or more metric values and a corresponding process identifier, and the status data causing the device to present, for each of the machine learning or artificial intelligence processes, a graphical representation of at least one of the determined one or more metric values within a digital interface.

13. The computer-implemented method of claim 12, wherein the process data for each of the machine learning or artificial intelligence process comprises a plurality of elements, each of the process data elements being associated with a corresponding one of the operations, and each of the process data elements being indicative of a success or failure of an execution of the corresponding one of the operations.

14. The computer-implemented method of claim 13, wherein:
the computer-implemented method further comprises:
using the at least one processor, determining, based on the process data elements associated with each of the machine learning or artificial intelligence processes, a first aggregate value characterizing a number of failed executions of the operations during one or more temporal intervals and a second aggregate value characterizing a number of successful executions of the operations during the one or more temporal intervals; and
computing, using the at least one processor, at least one of an aggregate failure rate or an aggregate success rate based on the first and second aggregate values; and
the status data comprises the first aggregate value, the second aggregate value, and the at least one of the aggregate failure rate or the aggregate success rate.

15. The computer-implemented method of claim 13, wherein:
the computer-implemented method further comprises:
using the at least one processor, and based on the process data elements, determining a first value characterizing a number of failed executions of the operations associated with each of the machine learning or artificial intelligence processes during one or more temporal intervals, and determining a second value characterizing a number of successful executions of the operations associated with each of the machine learning or artificial intelligence processes during the one or more temporal intervals;
computing, using the at least one processor, a rate of successful or failed execution of the operations associated with each of the machine learning or artificial intelligence processes based on corresponding ones of the first and second values; and
generating the status data comprises generating, for each of the machine learning or artificial intelligence processes, an element of the status data that includes the corresponding process identifier, the corresponding ones of the first and second values, and corresponding ones of the success and failure rates.

16. The computer-implemented method of claim 12, wherein:
the computer-implemented method further comprises obtaining, using the at least one processor, scheduling data associated with a corresponding one of the machine learning or artificial intelligence processes, the scheduling data comprising first temporal data and second temporal data, the first temporal data characterizing a scheduled initiation of a first one of the operations associated with the corresponding machine learning or artificial intelligence processes, and the second temporal data characterizing a scheduled provisioning of predicted output associated with the corresponding machine learning or artificial intelligence processes to a computing system; and
generating the status data comprises generating an element of the status data that includes the corresponding process identifier, the first temporal data, and the second temporal data.

17. The computer-implemented method of claim 16, wherein:
the computer-implemented method further comprises, obtaining, using the at least one processor, third temporal data associated with the corresponding machine learning or artificial intelligence process, the third temporal data characterizing a re-initiation of the first one of the operations based on a prior failure in an execution of the first one of the operations; and
generating the status data further comprises generating an additional element of the status data that includes the corresponding process identifier and the third temporal data.

18. The computer-implemented method of claim 12, further comprising:
using the at least one processor, obtaining a process identifier associated with at least one of the machine learning or artificial intelligence processes, and based on the process identifier, obtaining elements of scheduling data and process input data associated with the at least one machine learning or artificial intelligence process;
performing, using the at least one processor, operations that execute the one or more operations associated with the at least one machine learning or artificial intelligence process based on the process input data and the scheduling data; and
using the at least one processor, generating, for the at least one machine learning or artificial intelligence process, an element of the process data associated with each of the executed operations, the elements of the process data characterizing a success or a failure of corresponding ones of the executed operations.

19. The computer-implemented method of claim 12, wherein the status data further causes the device to:
generate and present, and for each of the machine learning or artificial intelligence processes, a first graphical representation of a first subset of the one or more metric values within a portion of a digital interface;
receive input data indicative of a selection of one or the first graphical representation associated with a corresponding one of the machine learning or artificial intelligence processes; and
based on the input data, generate and present a second graphical representation of a second subset of the one or more metric values associated with the corresponding machine learning or artificial intelligence process within an additional portion of the digital interface.

20. A device, comprising:
a communications interface;
a display unit;
an input unit;
a memory storing instructions; and
at least one processor coupled to the communications interface, the display unit, the input unit, and the memory, the at least one processor being configured to execute the instructions to:
receive, via the communications interface, status data associated with an execution of a plurality of machine learning processes, the status data comprising, for each of the plurality of machine learning processes, a process identifier and a value of one or more metrics characterizing a status of one or more operations that support the execution of the corresponding machine learning process;
based on the status data, generate and present, via the display unit, and for each of the plurality of machine learning processes, a first graphical representation of a first subset of the one or more metric values within a portion of a digital interface;
receive, via the input unit, input data indicative of a selection of one or the first graphical representation associated with a corresponding one of the plurality of machine learning processes; and
based on the input data, generate and present, via the display unit, a second graphical representation of a second subset of the one or more metric values associated with the corresponding machine learning process within an additional portion of the digital interface.
